(19) United States
(12) Patent Application Publication
(10) Pub. No.: US 2014/0019336 A1
(43) Pub. Date: Jan. 16, 2014

(54) SMART QUEUING FOR FINANCIAL TRANSACTIONS

(71) Applicants: Kyle David Browne, Charlotte, NC (US); Rosemary Hill, Jacksonville, FL (US); Daryoosh Shirbabadi, Charlotte, NC (US); Alejandro Vargas Hernández, Charlotte, NC (US)

(72) Inventors: Kyle David Browne, Charlotte, NC (US); Rosemary Hill, Jacksonville, FL (US); Daryoosh Shirbabadi, Charlotte, NC (US); Alejandro Vargas Hernández, Charlotte, NC (US)

(73) Assignee: Bank of America Corporation, Charlotte, NC (US)

(21) Appl. No.: 13/547,976

(22) Filed: Jul. 12, 2012

(51) Int. Cl. G06Q 40/00

(52) U.S. Cl. 705/39; 705/35

(57) ABSTRACT

Methods and apparatus according to the invention are directed towards providing electronic queuing of execution of financial services by a customer of a financial institution prior to the services being performed. Queuing may shift planning of and preparation for execution of the services, away from a time and/or a site of service-execution. Through queuing, the customer may securely produce, access and modify actionable electronic listings of services and of details of service-execution. The customer may securely activate the listings for the performance of service-executions via the institution's associates and/or machines. Queuing may expedite service-execution. The methods and apparatus may also provide for collaboration among customers in producing, accessing, modifying and activating listings.

### FIELD OF TECHNOLOGY

This invention relates to systems and methods for expediting execution of financial institution entity services. More specifically, this invention relates to customer-guided pre-staging of one or more entity transactional services prior to execution. The pre-staging may take the form of electronic queuing of transactional details desired by the customer. A given queue may be uniquely identified such that transactions queued therein may be expeditiously executed upon secure presentation of a unique identifier.

### BACKGROUND OF THE INVENTION

A financial institution entity (hereinafter, in the alternative, “financial institution,” “financial entity” or “entity”), such as a bank, may typically offer to business customers and/or non-business customers a breadth of financial transactional services. The transactional services may involve a variety of financial instruments maintained by and/or through the entity. Such instruments may include savings accounts, checking accounts, credit card accounts, investment accounts, insurance policies, loans, mortgages and home equity lines of credit.

Transactional services involving entity financial instruments may include deposit and withdrawal of account funds; transfer of funds among a customer's accounts and/or financial instruments (e.g., paying an entity mortgage bill from an entity business line of credit); transfer of funds to other customers' entity accounts and/or to non-entity accounts; payment of non-entity bills (e.g., paying a telephone bill); and issuing certified bank checks. Related ancillary services typically provided to customers may include opening and closing of entity accounts; preparation and transmission of account/instrument balance and/or transaction statements; and monitoring use of, and transmission of customer-directed alerts concerning, account overdraft privileges.

The entity may also offer customers a variety of non-transactional services. Non-transactional entity services may include business consultation; personal financial planning counseling; and secure maintenance of, and access to, safety deposit boxes.

The entity's breadth of service-offerings may benefit a customer by providing financial “one-stop shopping.” Benefits that may accrue to the customer may include enhanced efficiency in managing a host of financial instruments; familiarity with entity rules of engagement that may be congruent across the customer's various entity financial service-holdings; and opportunities to develop a relationship with, and a reputation among, entity associates handling the customer's various accounts.

A customer likely to benefit from the entity's breadth of service-offerings may be a customer with a plurality of entity transactions to execute, particularly entity transactions across several customer-held entity financial instruments. However, it may be such a customer that may also be distinctly limited in matching available customer timeslots to available entity timeslots for execution of the plurality of transactions. Similar limitations in matching customer timeslots to entity transactional timeslots may exist for other customers, such as a customer holding only a few entity financial instruments or a customer with only a few transactions to execute, but also with a constraining schedule and/or with other constraints on the customer's availability.

Limitations in matching available customer timeslots to entity transactional timeslots may be reduced through providing multiple brick-and-mortar entity branches, and by extending entity business hours. Multiple branches and extended business hours may offer customers more sites and more time in which to avail themselves of entity services, effectively expanding available entity transactional timeslots to encompass a wide range of customer timeslots and venues.

Expansion of available entity transactional timeslots to encompass a wide range of customer timeslots and venues, may be augmented through widespread use of Automatic Teller Machines (hereinafter, in the singular, “ATM”) and of on-line banking (hereinafter, “OLB”). ATMs and OLB may offer customers a broad range of after-hours and/or off-site transactional opportunities.

Historically, improvements in matching available customer timeslots to entity transactional timeslots through providing multiple brick-and-mortar entity branches and by extending entity business hours—as well as gains in expansion of available entity transactional timeslots to encompass a wide range of customer timeslots and venues through widespread use of ATMs and OLB—may be offset by increased breadth of financial institutions' service-offerings and by diminishment of customers' available timeslots.

Even with the broad range of after-hours and/or off-site transactional opportunities provided by ATMs and OLB, limitations on matching customer timeslots and entity timeslots may exist in several areas of customer-entity activities. Such areas may include transactions that may not be able to be conducted via ATM or OLB, or that the customer may be reluctant to conduct after-hours or off-site due to transaction-conditions and/or site-conditions. Such transactions and transaction-conditions may include opening an entity account; entity issuing of certified bank checks; customer depositing and/or withdrawing of cash; and transactions requiring concomitant signature or presence of an entity associate and/or of a notary public. Site-conditions that may contribute to customer reluctance to conduct transactions via ATM or OLB may include inadequate electronic and/or physical site-security; unavailability of desired cash denominations; and internet-access difficulties.

Other areas of customer-entity activities in which limitations on matching customer timeslots and entity timeslots may exist despite widespread use of ATMs and OLB, may include non-transactional customer-entity activities. Non-transactional services may typically require customer presence on-site during business hours at a brick-and-mortar entity branch customer service office. Non-transactional entity services may include providing customer access to a safety deposit box; authentication and/or registration of customer modification of signators on an account; and providing consultation with an entity loan officer.

Other factors may exacerbate limitations customers may experience in matching available customer timeslots to entity transactional timeslots despite widespread use of ATMs and OLB and despite availability of multiple branches and extended business hours. Such other factors may include sluggishly moving on-site customer-queues to access an entity machine, associate and/or function (hereinafter, in the singular, “entity functionality”). Waiting on such on-site customer-queues may expand the time required of a customer not just beyond the time that may actually be needed for execution of the entity service that may be desired by the customer but, also, beyond the timeslot that may be available to the customer.

It would be desirable, therefore, to provide apparatus and methods for granting customers the means to pre-stage, during customer-available timeslots, details of entity services to be subsequently executed on-site. It would be desirable, also, to provide pre-staging means in a fashion by which on-site execution of the desired services may be expedited, thereby reducing the on-site time required of customers. It would be desirable, also, to expedite on-site services in a fashion by which entity functionalities may be pre-alerted to the customer approaching the site of execution of services, so that entity preparation for the service-execution may be initiated prior to arrival of the customer.

### SUMMARY OF THE INVENTION

It is an object of this invention to provide apparatus and methods for customer-guided detailed pre-staging, during customer-available timeslots, of an entity service that a customer may select to have executed subsequently on-site. It is also an object of this invention to provide apparatus and methods for expediting on-site execution of a pre-staged service. It is also an object of this invention to provide apparatus and methods for initiating, prior to arrival of a customer, preparation of service-execution of a pre-staged entity service selected by the customer.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a block diagram of hardware apparatus that may be used in accordance with the principles of the invention;

FIG. 2 is an illustrative flow diagram of a process in accordance with the principles of the invention; and

FIG. 3 is another illustrative flow diagram of a process in accordance with the principles of the invention.

### DETAILED DESCRIPTION OF THE DISCLOSURE

Apparatus, methods and media are provided for implementing expedited on-site execution of financial services offered by a financial entity. The apparatus may include, and the methods and media may involve, components and functions that provide for customer-selection—during customer-determined times and/or in customer-determined venues—of details and/or parameters (hereinafter, “details/parameters”; in the singular “detail/parameter”) of the services to be subsequently expedited on-site. The components and functions may include and/or involve an interface operative between the customer and the entity through which customer-selection of services may be performed. The interface may present the customer with options and/or suggestions for customer-selection of services. The options and/or suggestions may be based upon entity-set defaults, customer entity-service history, and/or other suitable considerations. Other suitable considerations may include availability of entity on-site resources. The interface may allow for customer input of service-selections and/or of details/parameters of the services to be subsequently expedited on-site.

The customer-selected services may include a cash deposit, a check deposit, a funds withdrawal, a funds transfer between accounts, a funds payment to a third party and other suitable financial services offered by the entity. Other suitable services may include issuance of a certified check, access to a safety deposit box, and scheduling a meeting with an entity associate. Customer-selected services may include one or more services that may be executed in their entirety via ATM and/or OLB. Processing customer-selection of services may include customer-review and/or customer-modification of selections.

Customer-selection of services may include customer-setting of details/parameters associated with selected services(s). Alternatively and/or additionally, details/parameters associated with selected services may be entity-set. Details/parameters of selected financial services may include specification of timeslots for in-site service-execution; cash totals; cash amounts per denomination; individual checks' identifying numbers and/or amounts and/or payees and/or memo notations; third party payees' account numbers and/or other forms of identification; and/or other suitable service details/parameters. Other suitable service details/parameters may include an identifying number of a safety deposit box to be accessed; a loan-type and/or loan-amount to be discussed with an entity loan officer; and a timeslot in which the customer may wish to have a document notarized. Options and/or suggestions for customer-settings of services may be interface-presented. The interface-presented options and/or suggestions may be based upon entity-set defaults, customer entity-service history, and/or other considerations. Other considerations may include availability of entity on-site resources. Alternatively and/or additionally, interface-presentation may allow for customer input of service-associated settings. Processes of customer-setting of details/parameters of selected services may include customer-review and/or customer-modification of settings.

Processes of customer-selection of services and customer-setting of details/parameters may include entity-review and/or entity-modification of selections. Entity-review and/or entity-modification may reflect availability of entity resources relative to customer-selections and/or customer-settings. The customer may be informed of an outcome of entity-review and/or entity-modification. As an example, the customer may be informed of entity services that may achieve outcomes of the customer-selections and customer-settings with higher efficiency than the customer's service-selections and detail/parameter-settings. As another example, the customer may be informed of the unavailability for a customer-selected meeting of a customer-specified entity associate during a customer-set timeslot; the customer may be informed of alternate entity associates likely to be available during the customer-set timeslot and/or of alternate timeslots of availability of the customer-specified entity associate. The customer informed of entity-review and/or entity-modification may select to adopt, in whole or in part or not at all, the outcome of entity-review and/or modifications as effectively being the customer's service-selections and detail/parameter-settings; and/or may perform customer-review and/or customer-modification of the selections and/or settings; and/or may perform another set of service-selections and detail/parameter-settings; or may choose to cancel processes of customer-selection of services and customer-setting of details/parameters.

The customer's service-selections and detail/parameter-settings may be received via an entity associate, an entity computer and/or tablet and/or portable device, an OLB portal, an ATM and/or any suitable receiving means configured for receipt of service-selections and detail/parameter-settings according to the present invention. Suitable means may include video teller methodologies and/or video banking methodologies through which the customer may interface with an entity associate. Suitable means may include ATM-like apparatus dedicated to receipt of service-selections and detail/parameter-settings according to the present invention. Suitable means may include non-entity computers and/or tablets and/or portable devices configured for receipt of service-selections and detail/parameter-settings according to the present invention. Suitable means may include mobile devices configured (through function-enabling mobile device software applications; hereinafter, in the singular, “app”, such as a smartphone app) for receipt of service-selections and detail/parameter-settings according to the present invention. Suitable means may include the interface operative between the customer and the entity through which customer-selections of services may be performed. Suitable means may include an interface operative between the customer and the entity through which customer-settings of service-related details/parameters may be performed.

The apparatus may include, and the methods and media may involve, components and functions that provide for queuing the customer-selections and their associated customer-set details/parameters into a pre-execution listing of services to be executed on-site in accord with the service-associated settings.

Queuing the customer's service-selections and detail/parameter-settings may be conditional upon, and/or may signal, completion of customer-selection of services. The customer may select to complete customer-selection of services. Completion of service-selection may automatically result in queuing the customer selections into the listing. Alternatively and/or additionally, the customer may select to queue the customer selections into the listing, with or without signaling completion of service-selection. Selection of queuing may serve to complete service-selection processes. Completion of service-selection processes may include automatic selection of entity-set values for a particular selection. Such entity-set values may be based upon entity-set defaults, customer entity-service history, and/or other considerations. Completion of customer-selection of services may be subject to review and/or modification by the customer and/or the entity.

Queuing the customer's service-selections and detail/parameter-settings may be conditional upon, and/or may signal, completion of customer-setting of service-associated details/parameters. The customer may select to complete customer-setting of service-associated details/parameters. Such completion may automatically result in queuing a customer selected service, with its completed set of customer-set details/parameters, into the listing. Alternatively and/or additionally, the customer may select to queue the customer-selected service into the listing, with or without signaling completion of setting the service's associated details/parameters. Selection of queuing may serve to complete detail/parameter-setting processes. Completion of detail/parameter-setting processes may include automatic selection of entity-set values for particular details/parameters. Such entity-set values may be based upon entity-set defaults, customer entity-service history, and/or other considerations. Completion of customer-set details/parameters may be subject to review and/or modification by the customer and/or the entity.

The customer's service-selections, with associated detail/parameter-settings, may be ranked in the listing into a prioritized order-of-execution. Ranking of the service-selections in the listing into a prioritized order-of-execution may be subject to customer-control and/or entity-control.

Guidelines, instructions, algorithms, commands, components and/or functions for review and/or modification of ranking may be incorporated into the interface(s) operative between the customer and the entity through which customer-selections of services and/or service-associated settings may be performed. Review and/or modification of ranking may be performed prior to implementation of the listing for service-execution.

Guidelines, instructions, algorithms, commands, components and/or functions for review and/or modification of ranking may be implemented at entity site(s) of execution of the services. Review and/or modification of ranking may be performed during implementation of the listing for service-execution.

The ranking may be reviewed and/or modified by the customer and/or by the entity. Review and/or modification of ranking may be performed in accord with customer preference and/or in accord with availability of entity resources and/or in accord with other considerations. Other considerations may include availability of customer resources. As an example, a selected cash deposit into a customer account may be given a ranking that sets its execution prior to a selected withdrawal from that account of a customer-set amount greater than the pre-deposit balance but less than the post-deposit balance.

The apparatus may include, and the methods and media may involve, components and functions that provide for associating an identifier with the listing. The identifier associated with the listing may be stored. The listing may be stored. Storage of the identifier and/or the listing may be performed in conjunction with an entity database. The identifier may be linked with the listing. The identifier may be linked with stored identification information of the customer. The identifier may be linked with stored account information relevant to accounts that may be identified in the listing. Linking the identifier with the listing, with customer-identification information and/or with account information may be performed in conjunction with entity database(s).

The identifier associated with the listing may be a representation of the listed services and their detail/parameter-settings. The identifier associated with the listing may be unique. The identifier associated with the listing may be associated with a unique conveyable listing identifier (hereinafter, in the alternative, “LI”). The conveyable LI may be the identifier associated with the listing.

The conveyable LI may include a human-readable alphanumeric sequence (e.g., the identifier associated with the listing; a representation of the identifier associated with the listing; a coded form of the identifier associated with the listing; a code sequence representing the identifier associated with the listing); a machine-readable code and/or mark; and/or any suitable conveyable LI. Other suitable conveyable LI may include an audio signal, a holographic figure, an electromagnetic pattern, and/or a physical object. Such physical object may include a note produced by an entity associate, a visitor's badge, a card with a magnetic strip, a bar-coded article, and/or an instrument or device that includes an electronic chip. The LI may be incorporated into a cell phone, a mobile device and/or any suitable electronic, encoded and/or information-bearing article.

The customer may be provided selection options as to type, format and/or content of the LI. The customer may be provided selection options as to a quantity of LI(s). Selection options as to type, format, content and/or quantity of the LI(s) may be set by the entity. Availability of particular selection options may be pre-determined by capabilities of entity LI-recognition components and/or functions available on-site and/or off-site. Availability of particular selection options may be set by a level of security at a site and/or at a time of LI-recognition. Availability of particular selection options may be set by the nature of entity services to be executed (by, e.g., an amount to be transacted and/or a value ascribed by the entity to the customer).

LI selection options may include a LI that may already be in the customer's possession, such as a banking card, a biometric feature of the customer, a Personal Identification Number (hereinafter, “PIN”) and/or an answer to a security question.

The LI may be confirmed, transmitted, issued and/or conveyed to the customer. The confirmation, transmission, issuance and/or conveyance of the LI to the customer may be performed entirely, partly or not at all by electronic means, depending at least partly on the types, formats, contents and/or quantity of LI(s) available from the entity and/or selected by the customer. The confirmation, transmission, issuance and/or conveyance of the LI to the customer may be performed in a highly secure fashion.

The confirmation, transmission, issuance and/or conveyance of the LI to the customer may not be required to be performed in a highly secure fashion. Subsequent secure receipt and acceptance of the LI by the entity may provide a requisite level of security for execution of selected service(s). The requisite level of security for execution of selected service(s) may be determined by the entity. The requisite level of security for execution of particular selected service(s) may call for a complementary and/or supplementary LI.

The customer may convey the LI to an entity site for receipt of the LI resulting in expedited execution of the selected services in accord with the detail/parameter-settings. The entity site may have been selected and/or identified in the service-selections and detail/parameter-settings. The conveying by the customer of the LI may be performed at least partly by electronic means if such conveyance may be compatible with mode(s) of the secure receipt of the LI. Different modes of secure receipt of the LI may be available to the customer. Different modes of secure receipt of the LI may be available at different entity sites. The customer may have the LI conveyed to the entity site by a designated representative of the customer if such representation is compatible with the nature of the LI and with requirements of the mode(s) of secure receipt of the LI.

The apparatus may include, and the methods and media may involve, components and functions that provide secure receipt by the entity of the LI from the customer. Processes of secure receipt may include receipt of the LI from the customer and acceptance of the LI. Acceptance of the LI may include comparing the LI to the identifier associated with the listing. Processing secure receipt of the LI may include receiving secure, verifiable customer-identification (hereinafter, in the alternative, “customer-ID”). Secure, verifiable customer-ID may include each of, multiple forms of, all of, or any combination of: answer(s) to security question(s); a form of photograph-bearing identification (e.g., a driver's license); a PIN; and/or any acceptable, secure means of identifying the customer. Acceptable, secure means of identifying the customer may include use of a value associated with a biometric feature of the customer (e.g., a voiceprint, a fingerprint, a retinal scan or DNA) or with an article of identification securely physically associated with the customer (e.g., an implanted identification chip). Secure, verifiable customer-ID may be verified against entity customer-ID information.

Components and functions for receipt and verification of the LI may be located and/or functional on-site. Components and functions for receipt and verification of customer-ID information—by which, receipt of the LI may be rendered secure—may be located and/or functional on-site. Components and functions for secure receipt and acceptance/verification of the LI may include and/or involve an entity functionality. The entity functionality may be dedicated to secure receipt and acceptance/verification of LIs.

Upon secure receipt and acceptance/verification of the LI, components and functions of the present invention may be alerted to assemble (e.g., to retrieve from entity databases, to initiate processing) information regarding customer-ID, account-identification, the listing, the ranked services in the listing, and/or the detail/parameter-settings of the services. The assembled information may be available to entity functionalities prior to the customer being in direct proximity of an entity functionality to have the selected services executed in accord with the detail/parameter-settings. Such assembling of information may prime an entity functionality at the service-execution-site for implementation of an expedited execution of the service(s).

The entity functionality may be dedicated to expediting execution of the details of services customer-selected via apparatus, methods and/or media of the present invention. The entity functionality may be alerted, prior to execution of customer-selected services, to customer-expectation of the execution being expedited. The entity functionality may be primed, prior to execution of customer-selected services, with information that may facilitate implementation of an expedited service-execution. Such information may include at least the listing of the customer service-selection(s) and associated detail/parameter-setting(s). Prior to execution of the service(s), the customer may be informed of any entity factors that may affect expedited execution of the service(s). Prior to execution of the service(s), the customer may be given the option to perform customer-review and/or customer-modification of selections and/or of detail/parameter-settings.

Entity functionalities may preferentially expedite service-executions for the customer that pre-staged service executions in a listing linked to an LI over service-executions of another customer that pre-staged service executions in a listing linked to a LI, on the basis of factors. Such factors may include relative complexity of the service-executions of the two customers, relative urgency of the service-executions of the two customers, relative recency of receipt of the LIs of the two customers, and/or other suitable factors. Other suitable factors may include relative monetary values associated with the service-executions of the two customers and relative entity-value of the two customers.

Entity functionalities may preferentially expedite service-executions pre-staged in a listing linked to an LI over non-pre-staged service-executions.

The apparatus may include, and the methods and media may involve components and functions that provide for alerting entity functionalities of the proximal approach of the customer prior to receipt of the LI by the entity. Such alerting may be used to prime entity functionalities for receipt of the LI and/or for implementation of expedited execution of the customer service-selections in accord with the detail/parameter-settings. The components and functions may provide for tracking and/or monitoring the location of the customer relative to the site of anticipated and/or actual secure receipt of the LI and/or relative to the service-execution-site. Tracking and/or monitoring may involve global positioning system (hereinafter, “GPS”) capabilities of the customer's cell phone. Tracking and/or monitoring may involve on-site means for locating the customer. On-site means for tracking and/or monitoring may involve issuing a trackable visitor's badge to the customer upon secure receipt and verification of the LI and/or conveying a trackable LI to the customer.

Alerting entity functionalities to the proximal approach of the customer prior to the customer being in direct proximity of an entity functionality to have the selected services executed in accord with the detail/parameter-settings, may be termed hereinafter “pre-execution alerting.” Pre-execution alerting may involve continual and/or intermittent tracking and/or monitoring, such as effected through multiple GPS determinations of the location of the customer's cell phone, multiple determinations of the customer's on-site location, and/or on-site readings of one or more biometric features of the customer.

Pre-execution alerting may proceed in stages that are sensitive to tracked/monitored proximity of the customer relative to an entity site of LI receipt and/or of service-execution. For example, stages of pre-execution alerting may proceed from a standby level when the customer's GPS-tracked cell phone may be approaching the entity site; to a low-activity level upon the customer's GPS-tracked approach occurring close to a time-parameter set on the listing for execution of the selected services; to a moderate-activity level upon the customer being proximal to a site of secure receipt of the LI, at which site biometric and/or other verification of the customer's identity may complement receipt of the LI; to a high-activity level, upon completion of customer identity verification and LI receipt and/or upon the customer proceeding toward the service-execution-site.

In a case of a customer that had selected meeting with an entity associate to discuss a given matter, a standby level alert may notify the entity associate of the possible approach of the customer, bringing up the customer's stored identification information for the entity associate's reference; a low-activity level alert may notify the entity associate of the appointment and of the possible upcoming need to finish or put aside non-appointment-related activities; a moderate-activity level alert may notify the entity associate of the likely imminent arrival of the customer and may bring up appointment-related files on the matter to be discussed; and a high-activity level alert may notify the entity associate how to meet and greet the customer (e.g., customer's name, title and, if applicable, nickname and/or diminutive; customer's face-picture; customer-details relevant to a greeting and relevant to the meeting) and where on-site to do so concomitant with a verification of customer identification by components and functions of the invention (hereinafter, the invention, in broad terms, may be referred to, in the alternative, as “Smart Queuing”). The detail/parameter-setting interface and/or the LI receipt site may be configured to provide the customer similar information regarding the associate, such as the associate's name, title and picture, as well as information as to where on-site to meet the associate.

In a case of failure of verification and/or rejection of customer identification by components and functions of the invention at any of the stages of pre-execution alerting, such alerting may notify the entity associate of attempted account fraud. The entity may be primed for such notification by an entity customer informing the entity of loss or theft of the customer's banking card, PIN and/or other forms of identification. Biometric-reading technologies and other customer-ID methodologies of Smart Queuing may also detect attempted account fraud in cases not lending themselves to such priming. A notification of attempted account fraud may also be transmitted to supervisors of the entity associate and/or to law enforcement authorities on-site and/or off-site.

Several examples of scenarios of entity service pre-staging may serve to showcase components, functions, operations and features of the present invention.

### Example A

Example A may illustrate the use of Smart Queuing interfaces presented to a customer for production of a listing of pre-staged services and for subsequently accessing the listing to modify it and to execute the listed services.

In Example A, an entity customer, Customer A, may be a businesswoman owning and operating a small retail store. The store's income may comprise a mix of credit card transactions and cash, the latter typically being deposited semi-weekly, usually on Tuesdays and Fridays. An entity ATM, far from a local brick-and-mortar entity branch at which Customer A does her on-site banking, may be conveniently located within walking distance of her store. But, Customer A may often be too busy during business hours to access the ATM and may regard the ATM's locale as inadequately secure for the conveyance of deposit-worthy amounts of cash. Customer A may regard the branch's locale, as well, to be inadequately secure after hours. She may, therefore, make her cash deposits in person at the branch during business hours, such trips to the branch also providing Customer A access to additional bank services. The scheduling of timeslots for her trips to the branch may, however, be constrained by her store activities, with the result that she may occasionally miss at least one of her two usual weekly timeslots. To alleviate her scheduling difficulties, Customer A may avail herself of services and functions of the nearby ATM for after-hours transaction pre-staging, the ATM having been configured to support entity-customer interfaces according to the present invention.

During an exemplary week, Customer A may have planned her Tuesday branch trip to include allocating her cash deposit between two of three entity accounts, and also having a certified bank check issued against funds in the third account, but may not have had an available timeslot for the trip. With the upcoming Friday timeslot now having to also accommodate the Tuesday banking activities, Customer A may wish to make the Friday trip as efficient as possible. Customer A may prepare for her Friday trip by visiting the nearby ATM after hours on Tuesday, bearing no store cash to be deposited.

At the ATM, Customer A may access entity service-selection and detail/parameter-setting interface(s) supported by the ATM via standard procedures of swiping a bank card, entering a PIN and selecting an option. The option may be titled “Smart Queuing—Pre-Stage Services.” Using the interface(s), Customer A may specify, through menus of selection options and inputs: the local brick-and-mortar entity branch as the service-execution-site; her entity accounts to and from which funds are to be moved; cash amounts to be deposited into the two accounts; and details of the certified bank check to be issued against the third account. Using the interface(s), Customer A may indicate her approximate anticipated available timeslot for Friday on-site execution of the selected services.

The interface may present Customer A several options as to available LIs. From the options, Customer A may select a human-readable alphanumeric sequence, such as her spouse's birthdate. Customer A may select the option of inputting a prompt question (such as “J's BD?”) to remind her of the inputted LI, and may then signal readiness to close the ATM session. Upon Customer A closing the ATM session, a listing of the selected services and the detail/parameter-settings may be associated in entity database(s) with Customer A's customer-ID information and with the selected LI.

By Thursday evening, the need may have arisen for a second certified bank check to be issued and for a wiring by week's end of funds to an offshore supplier's account, both from Customer A's second account. Returning to the ATM, Customer A may swipe her bank card, enter her PIN, and select the “Smart Queuing—Pre-Stage Services” option, as before. The pre-staging interface may open with a prompt to submit a new listing of service-selections and/or detail/parameter-settings, and/or to edit or cancel the previous, still unexecuted listing (hereinafter, “UL”).

Customer A may select to edit the previous listing. To access the previous listing for editing, she may be prompted to input her previous selection of alphanumeric LI, for which she may request first the prompt question she had previously entered. Customer A may, as addenda to the previous listing, specify details of the second certified bank check and of the offshore wire. She may also update the cash amounts to be deposited into her accounts.

Upon Customer A signaling having completed editing the listing, the interface may present her with several options as to LIs for the edited listing, including the option of keeping the current LI. Wanting to optimize her Friday timeslot for on-site execution of the selected services in accord with detail/parameter-settings, Customer A may opt for a LI that may be transmitted and scanned electronically, such as a machine-readable Quick Response Code (“QR Code”) identifier, to expedite on-site execution. Customer A may opt for the QR Code to be sent to her smartphone.

The next day, as her day's schedule unfolds, Customer A may decide to go to the local brick-and-mortar entity branch earlier than she had anticipated, well before the timeslot included in the detail/parameter-settings. The approach of Customer A's GPS-enabled smartphone to the branch may trigger a standby level alert that brings Customer A's identification-information to the computer screen of an entity associate handling pre-staged services. Customer A's earlier-than-listed approach to the branch may not trigger a low-activity level alert, leaving the entity associate with Customer's A identification-information, but without a signal of urgency attached to it.

Upon entry on-site, Customer A may go directly to an available ATM-like apparatus dedicated to implementing functions of the present invention. Customer A may swipe her bank card and enter her PIN. Her entry on-site and/or entity processing and verification of her on-site inputs may trigger an alert at a moderate-activity level. The alert may bring to the screens of the entity associate and of a supervisor of the associate Customer A's identification-information, her ranked listing of service-selections and detail/parameter-settings, and entity information pertinent to her accounts. The identification-information and the listing may be accompanied by a signal of Customer A's need to have an entity associate handle at least her certified checks and funds-wiring. The supervisor may determine if and when the entity associate will be available. If the entity associate will not be available, the supervisor may transfer the information, listing and service-handling to an available entity associate. The entity associate and/or the supervisor may indicate the identity of the available entity associate, with an estimate of the availability of the entity associate, to be signaled to Customer A via the ATM-like apparatus.

At the ATM-like apparatus, entity processing and verification of Customer A's swiped bank card and PIN may bring to a touchscreen of the ATM-like apparatus a prompt to present for scanning the QR Code LI transmitted to Customer A's smartphone. Customer A may bring the QR Code to the smartphone display and present the display for scanning by the ATM-like apparatus. Verification of the LI may bring to the touchscreen Customer A's ranked listing and several options pertinent to execution of the listed services. Customer A may be presented with options that include: Further alerting an entity associate to Customer A's presence at the ATM-like apparatus even before she may complete her session there; allocating the execution of Customer A's deposits to the ATM-like apparatus and allocating to an entity associate the issuing of Customer A's checks and the offshore wiring of funds, or having all the selected services performed by the entity associate; and/or reviewing/modifying the listing's service-selections and/or detail/parameter-settings.

In the interest of enhanced expediting of her transactions, Customer A may opt for further alerting an entity associate immediately, and for having all transactions executed by the entity associate. Customer A may also opt to review/modify the listing.

The supervisor and/or entity associate may be informed of Customer A's selection of options of enhanced expediting. The informing may be in the form of an alert at a high-activity level, with indication of Customer A's expectation of the entity associate executing all listed services, and with information on how to meet and greet the customer.

After reviewing/modifying the listing on the touchscreen, Customer A may indicate completion of her session at the ATM-like apparatus. The entity associate may be sent the reviewed/modified listing. Customer A may be sent information on the identity, availability and location of the entity associate handling expediting the execution of Customer A's selected transactional services. The information sent to Customer A may be sent to her smartphone and/or to the touchscreen of the ATM-like apparatus. The ATM-like apparatus may close Customer A's session.

Customer A may leave the ATM-like apparatus to make her way to the entity associate. Her approach toward the entity associate may be tracked. Any updates to the information sent her as to the identity, availability and location of the entity associate handling expediting the execution of her selected transactional services, may be sent to her smartphone.

The entity associate may be primed to recognize Customer A and to greet her by name. While Customer A approaches the entity associate and/or while the entity associate greets Customer A, an identity-confirming electronic reading may be taken of a biometric feature of Customer A and/or Customer A may submit a biometric feature to be scanned (by means of, e.g., facial recognition technology, an iris scanner, a fingerprint reader). Identity-confirmation may be followed by the execution by the entity associate of all of Customer A's selected entity services according to the detail/parameter-settings of the listing. With the entity associate readied and primed to execute Customer A's selected transactions, the execution may be expedited, allowing Customer A to return to her store with minimal time spent at the branch.

### Example B

Example B may illustrate the use of diverse platforms for production and for accessing Smart Queuing listings.

In Example B, an entity Customer B may be a graduate student in computer science sharing an apartment with other students. All the students may prefer to do their banking on-line. Customer B may utilize an OLB portal via a tablet computer to pre-stage entity transactions involving a single personal entity account. He may subsequently have the pre-staged transactions executed through a site-secure ATM that may be configured to implement functions of the present invention. Typically, Customer B may wait until his pre-staged transactions accumulate and/or aggregate in monetary sums to a point relative to his needs that he feels may warrant his walking to the site-secure ATM. The ATM he typically uses may not be located at a brick-and-mortar entity branch; Customer B's transactions may rarely require the attention of an entity associate.

Customer B may typically access Smart Queuing pre-staging interface(s) via his OLB portal. Through the interface(s), he may select entity services and set service-associated details/parameters. He may accept entity-ranking and entity-review/modification of his listing. Customer B may indicate, in a Smart Queuing pre-staging interface input of a customer-comment, personal reservations he may have about his OLB portal's level of security. The reservations may stem from an occasion in which Customer B may have neglected to close his OLB portal before leaving his tablet unattended in his apartment.

In each OLB pre-staging session preceding a trip to the ATM, Customer B may typically select an entity-offered default alphanumeric code as his LI. He may select to have the LI sent to his phone for later visual reference. He may access and adjust the listing over several days until he may be ready and/or need to have his accumulated and/or aggregated transactions executed at the ATM.

At the ATM, Customer B's protocol for accessing the listing may be different from that of Customer A in the previous example. Customer A having securely and consistently performed her pre-staging of entity services and selection of LI(s) at the ATM near her store, may not have flagged a need for enhanced security to be associated with Customer A accessing her listing via ATM. Customer B having performed his pre-staging of entity services and selection of LI(s) via OLB (and his having indicated reservations about his OLB portal's security) and then shifting to the ATM for execution of services, may flag a need for enhanced security to be associated with Customer B accessing his listing via ATM. A heightened security may be associated with receipt of the LI preceding accessing Customer B's listing.

Customer B may access Smart Queuing interface(s) at the ATM via standard procedures of swiping a bank card, entering a PIN and selecting a Smart Queuing option. The ATM Smart Queuing interface(s) may not present Customer B an option of accessing his listing before verification of his identity. Customer B may be required to first input a biometric feature (such as a fingerprint submitted for scanning), an answer to a security question and/or other suitable identification-verifiable input; multiple different inputs may be required. Other suitable identification-verifiable input may include a camera scan of Customer B's face for facial recognition analysis. The area surrounding the ATM may be swept by camera to check for signs of coercion or of suspicious behavior on the part of Customer B and/or others in the area.

After verification of Customer B's identification-input, and/or of Customer B's presentation thereof being uncoerced and/or proper, the ATM-interface may request input of Customer B's LI. Following secure receipt of the LI, the interface may present Customer B's listing of service-selections and detail/parameter-settings. Customer B may be presented outcomes of entity-review/modification of entries in the listing. Customer B may adopt the outcomes. Execution via the ATM of all of Customer B's selected entity services according to the detail/parameter-settings of the listing may proceed to Customer B's satisfaction.

Infrequently, when Customer B's banking activities may require attention of an entity associate, Customer B may visit a brick-and-mortar entity branch. Prior to the visit, Customer B may access Smart Queuing interface(s) by standard procedures via his OLB portal. He may select services and set service-associated details/parameters covering his upcoming visit, during which he may plan to also do his usual banking. His selections and settings may include a selection and/or inputting of the service(s) requiring entity associate attention. His selections and settings may include an anticipated timeslot for the visit. Customer B may adopt outcomes of entity-review/modification of his listing, which may include a slight shift of designated timeslot to match the availability of an entity assistant familiar with the selected attention-requiring service(s). Customer B may accept an entity-offered default alphanumeric code LI, and may have it sent to his phone. Customer B may close his OLB-mediated Smart Queuing session.

Close to the beginning of the designated timeslot, Customer B may arrive at the entity branch. His arrival may be tracked by the location of his GPS-enabled phone and/or via facial recognition scanning upon his entry into the branch. His arrival may trigger a moderate-activity level alert. The alert may result in notification of the entity associate familiar with Customer B's attention-requiring service(s). The notification may inform the entity associate of Customer B's proximity. The alert may result in information pertinent to Customer B, his visit and his selected attention-requiring service(s) being assembled for the entity associate's review.

Customer B may follow signage directing Smart Queuing entity customers to one of several ATM-like apparatus dedicated to implementing functions of the present invention. Some of the apparatus may be located in a signage-indicated row, separated from each other by small distances and privacy partitions. Some of the apparatus may be located as stand-alone units at discrete signage-indicated locations within the entity branch. Customer B may have followed the signage to a stand-alone unit.

At the dedicated ATM-like apparatus, Customer B may access his listing by following enhanced security procedures of swiping his bank card, entering his PIN, submitting a biometric feature and, after verification of his identity, entering the LI that he may first bring to his phone's display for visual reference. Customer B may update his listing, reviewing/modifying the listed service-selections, detail/parameter-settings and rankings to more closely match his perceived current banking needs. He may accept an entity-offered outcome of entity-review/modification of his listing. He may accept an entity-offered allocation of service-selections in the listing between those service(s) that may be executed at the ATM-like apparatus and those service(s) that may require attention of the entity associate. The entity associate may be notified of Customer B's acceptance of the entity-offered allocation of service-executions. The entity associate may be notified, on the basis of the nature, number and details/parameters of the services to be executed at the ATM-like apparatus, of an approximate time of Customer B closing his session at the ATM-like apparatus.

Customer B, following ATM-like screen prompts, may execute at the ATM-like apparatus the selected services entity-allocated to the ATM-like apparatus. Customer B may signal his completion of ATM-allocated services. The entity associate may receive a high-activity level alert, including meet-and-greet information as well as information regarding Customer B's location within the branch. Customer B, still at the ATM-like apparatus, may receive information as to the name, title and location of the entity associate. Customer B may opt for a printout of the information relating to the entity associate. With the printout in hand, Customer B may leave the ATM-like apparatus, but may neglect to close his session there. The session may be closed automatically within a fraction of a second after Customer B leaves the ATM-like apparatus. The session may close automatically even if no one else approaches the ATM-like apparatus.

Customer B may become distracted on his way to the entity associate. The entity associate may be notified of Customer B's track toward the entity associate becoming irregular and/or of the time elapsed from the close of the session at the ATM-like apparatus exceeding a reasonable transit time from the ATM-like apparatus to the entity associate. If deemed appropriate, the entity associate may go to meet and greet Customer B. Customer B may consult with the entity associate. The entity associate, having had time and information for preparation, may execute the attention-requiring service-selection(s) in an expeditious fashion to the satisfaction of Customer B.

### Example C

Example C may illustrate collaboration in the production and modification of ULs through Smart Queuing interfaces.

In Example C, entity Customers C1, C2 and C3 may be business partners living in the home-base city of their business. They may be a man, a woman and their married son, each with a full and hectic schedule.

Each of the three partners may have an equal voice in defined areas of financial decision-making of the business. The partners may appreciate each other's input in decision-making. They may trust each other's decisions. They may arrive at those decisions with rapid precision. A significant portion of decision-making input as well as many other activities of the business may be performed via secure mobile devices. Each partner may carry a security-enabled mobile device.

Customers C1, C2 and C3 may be considered valued customers by the entity. Their business may hold several large and growing entity business accounts. Their entity-holdings and business operations may often but irregularly require attention from, and customer-consultation with, entity associates, particularly entity business specialists.

The partners' schedules may be such that usually only one of them, any one of the three, may be available for one of the business's frequent on-site visits to a bustling brick-and-mortar entity branch located in their business home-base city. The partners may maintain key business documents in a safety deposit box housed in the branch's vault. Most of the business's many on-site entity service-executions may be performed at the branch. Entity associates familiar with the partners and with their business may be located at the branch.

The partners may make frequent use of Smart Queuing as a means of coordinating their schedules relative to availability of the branch entity associates. The partners may make frequent use of Smart Queuing as a means of aggregating and optimizing pre-staged on-site entity service-executions.

Customer C1 may be out-of-town on a business day-trip, planning on returning late at night to the business home-base city. Need for on-site execution of several entity services not requiring an entity associate may arise during the trip, but may be of insufficient urgency to require a visit during the trip to an out-of-town entity site. One of those services may be a cash deposit to one of the business's entity accounts. Additionally, a matter calling for consultation with a particular entity associate business specialist familiar with the partners' business may arise during the trip. Customer C1 may wish to pre-stage a meeting for the following morning with the entity associate. Customer C1 may wish to pre-stage the cash deposit for the same on-site visit. Customer C1 may wish to pre-stage, as well, the other service-executions for the same on-site visit. Customer C1 may know that, as of his departure in the morning, the business had no other services to be executed on-site at the entity branch.

Via his mobile device, Customer C1 may access Smart Queuing interface(s) for service-selection and detail/parameter-setting. He may gain access to the interface(s) by submitting a personal PIN, an answer to a personal security question and a business identification code. The business identification code may be shared by all three partners.

Customer C1 may expect the interface(s) to open with presentation of an option to pre-stage services, facilitating his producing a listing of service-selections and service-related detail/parameter-settings. Instead, the interface(s) may open with presentation of multiple options to review/modify a UL of service-selections and detail/parameter-settings; to cancel the UL as part of the review/modify option; and/or to produce another listing.

It may be clear to Customer C1 that the UL indicated by the interface had been produced in the interim since his departure by one or both of Customer C2 and Customer C3. The three business partners may share the production and the review/modification of listings in anticipation of any one of the partners having opportunity and/or need to visit the entity branch. Customer C1's need to visit the entity branch the next day may provide opportunity for execution of the listing's selected services.

Customer C1 may wish to add to the listing a meeting the next day with the entity associate at the branch. Customer C1 may wish to also add to the listing the matters not requiring an entity associate's attention that arose during the trip. Customer C1 may wish to aggregate, if possible, the execution of those matters with other service-executions already listed; for example, Customer C1 may wish to see if any of the services pre-staged through the UL may be a transaction involving the account that he may want to deposit cash into.

Customer C1 may wish to access the UL to review/modify it to incorporate pre-staging of service-executions arising from his trip. Expecting to be the partner to handle all the listed services on his visit the next day to the entity branch, he may wish to review and modify the ranking of listed services to accommodate his business banking preferences and style.

When Customer C1 may select from the options presented via the interface(s) on his mobile device for review/modification of the UL, the interface(s) may present a prompt associated with a LI to be inputted. The partners may generally use, and set prompts for, alphanumeric LIs. The prompts may be slightly cryptic prompts that may be readily interpreted by all three partners. The prompts may be meaningless to others.

Customer C1 may be certain of two different interpretations of the prompt. He may input a LI based upon one of the likely interpretations of the prompt. The inputted LI may be incorrect. Customer C1 may be notified of rejection of his input. He may be notified via the interface(s) of the rejection. The interface(s) may present an option of cancellation of accessing the UL and ending the Smart Queuing session, or of a second inputting of a LI. Customer C1 may opt for a second inputting.

Customer C1 may also receive an urgent automatic text message from the entity, notifying him of a failed attempt at accessing Smart Queuing listings via his PIN and other ID information. The text message may inform Customer C1 that he may be notified of any other failed attempts, and that law enforcement authorities may be notified after a particular number of failed attempts. The text message may also indicate that Customer C1's banking card, PIN number other ID information may be frozen and flagged by the entity upon that particular number of failed attempts. The text message may suggest that Customer C1 immediately contact the entity if it was not he who entered his PIN and other ID information.

Having opted for a second inputting of a LI, Customer C1 may be presented by the interface(s) with a requirement to answer a second personal security question before starting to input a second LI. The initial failure of Customer C1 to enter the correct LI may raise the security level to be satisfied to input a second LI. The interface(s) may require Customer C1 to submit a real-time face-picture and a fingerprint via his mobile device's camera. Customer C1 may do so and may be given access to the interface screen featuring the prompt.

Customer C1's second input of a prompt-based LI may be accepted, granting him access to the UL. He may augment the UL by pre-staging service-executions arising from the day-trip. He may pay particular attention to the interface's presentation of scheduled availability of the particular entity associate, setting times for the other service-executions around the associate's schedule. He may modify the UL to aggregate some service-executions. He may modify the UL ranking and other features to accommodate his business banking preferences and style. He may retain the LI and prompt. He may signal his acceptance of the modified UL, the LI and its prompt; and he may close the interface and his Smart Queuing session via his mobile device. Prepared for the next day's visit to the entity branch, Customer C1 may set out for home.

Several hours of driving later, Customer C1 may arrive at home to find a note left by his now-sleeping wife and business partner, Customer C2. The note may reference the “security irregularity” the partners had received entity text messages about. The note may convey instructions to “leave the cash” in a specified location in the house. Checking his email, Customer C1 may find a message from his son and business partner, Customer C3, congratulating Customer C1 on correctly, if belatedly, interpreting Customer C2's prompt that she had set with her UL. The email may also delineate Customer C3's urgent need for an on-site visit at the entity branch and his assurances that, given background information, he may competently handle the meeting that Customer C1 had scheduled.

Aware of late hours kept by his son, Customer C1 may call him to fill him in on the day-trip and, in particular, on details of the need arising therefrom to meet with the particular entity associate business specialist. Duly informed, Customer C3 may reaffirm his own ability to handle the meeting scheduled by Customer C1.

Customer C3 may assure his father that almost all the UL accepted by Customer C1, as well as Customer C3's need, could be handled during Customer C3's on-site visit. A single exception, the cash deposit that Customer C1 had pre-staged, would not be possible through Customer C3's on-site visit, but could be handled during the day by Customer C2 via a standard site-secure ATM near the partner's business. Mother and son may have consulted after Customer C3's need arose, while Customer C1 was in transit on his way home, and may have arrived at a strategy by which all the business's pre-staged service-executions could be performed with a minimum of partner “down-time” at the entity branch. Afterwards, Customer C1 may access the UL and may find, as expected, that it had already been augmented to accommodate his son's need to visit the entity branch. He may also find the meeting he has set with the entity associate business specialist rescheduled to a different timeslot. He may find the UL modified, as well, to accommodate his son's business banking preferences and style, including an expectation of receiving valued-customer treatment. Customer C1's pre-staged cash deposit may no longer appear on the UL.

As Customer C1 may be reviewing the UL, he may receive an onscreen notification of his son accessing the UL and selecting to modify it. Customer C1 may be given an option of actively participating in the modification process, including accepting or rejecting participants' modifications, or of simply viewing it real-time. Customer C1 may opt to view the process as a non-participant.

Customer C1 may then view a few changes being made to the UL, followed by acceptance of the modified UL and then by his son's Smart Queuing session closing. Customer C1 may note that one of the changes made by his son to the UL may have been a reallocation of a particular machine-executable service to execution by and/or with an entity associate. Upon selection of that change, the screen may have presented the names, areas of expertise and availabilities of several entity associates expected to be present at the entity branch around the timeslot of the rescheduled meeting with the entity associate business specialist. Customer C1 may note that his son may have selected the business specialist as the entity associate for the additional associate-executed service, and may have correspondingly lengthened the meeting timeslot. Confident that their business may be in good hands, Customer C1 may close his own session. Before going to sleep, Customer C1 may “leave the cash” as instructed.

The next day, Customer C3 may arrive at the entity branch close to the time of the scheduled meeting. His tracked approach close to the scheduled meeting-time, coupled with the business's valued-customer status that Customer had invoked on the UL, may trigger a moderate-activity level alert wherein a dedicated Smart Queuing machine may be reserved for his use. Through the alert, the entity associate business specialist may be supplied with assembled information relevant to both matters of the scheduled meeting and may be notified to prepare for the meeting. The entity associate may be given an estimate of time available for preparation; the estimate may be based upon the particular allocation of Customer C3's listed services between execution via machine and execution via the entity associate.

As Customer C3 arrives on-site, face-recognition technology may verify his identity. Upon verification of Customer C3's identity, his mobile device may receive and display entity instructions for finding the reserved dedicated machine. At the machine, where a confirmatory facial recognition scan may be performed, Customer C3 may submit his fingerprint as a second form of personal identification. Upon verification of the presence of Customer C3 at the machine, a screen of the machine may present a discretely personalized greeting and may request input of the LI. Upon input and verification of the LI, Customer C3 may be presented onscreen with the UL and may be asked for any pre-execution modifications of UL features. Having fully modified the UL the previous night to accommodate his own business banking preferences, style and needs, Customer C3 may opt for proceeding directly to ranked execution of services.

Several machine-executions later, as Customer C3 may be about to close the machine phase of his Smart Queuing session, the entity associate may be directed to the dedicated machine Customer C3 may be using. The associate, bearing an entity tablet receiving notifications of stages of Customer C3's progress in his Smart Queuing session, may personally greet Customer C3 at the dedicated machine just after Customer C3 may receive onscreen identification information, including a current face-picture, of the associate. The entity associate may usher Customer C3 to an office where they may discuss the matter that arose in Customer C1's business trip and execute the service that Customer C3 had reallocated from machine-execution.

### Example D

Example D may illustrate on-site time-savings accruing to Smart Queuing customers.

In Example D, Customer D may be an entity customer that rides a bus to and from work. Customer D's workplace may be near a site-secure ATM configured to support Smart Queuing. Before using Smart Queuing, Customer D may have typically spent an average of four minutes once a week at the ATM, conducting most of Customer D's weekly machine-executable entity service-executions. Those four minutes may include time wasted on mistaken ATM inputs on the part of Customer D. Those four minutes did not include time spent waiting on line for access to the ATM.

Since adopting Smart Queuing, Customer D may produce anew and/or review/modify a weekly UL on a portable device while riding the bus. The UL may feature entity-review/modification for efficient order of execution of services. The new and/or modified UL may be error-free. Smart Queuing Customer D may now spend an average of two minutes once a week at the ATM, conducting all of Customer D's weekly machine-executable entity service-executions. Those two minutes may include time spent conducting machine-executable entity services that Customer D had previously conducted via an entity associate because those services may have taken too long to practically and/or politely conduct at an ATM. Customer D may notice that, as other ATM-users adopt Smart Queuing, less time may be spent waiting on line for access to the ATM. (It may be noted that the exemplary details of this and other examples herein are presented by way of illustration and not limitation.)

Illustrative embodiments of apparatus and methods in accordance with the principles of the invention may be described with reference to the accompanying drawings, which form a part hereof. It is to be understood that other embodiments may be utilized and that structural, functional and procedural modifications may be made without departing from the scope and spirit of the present invention.

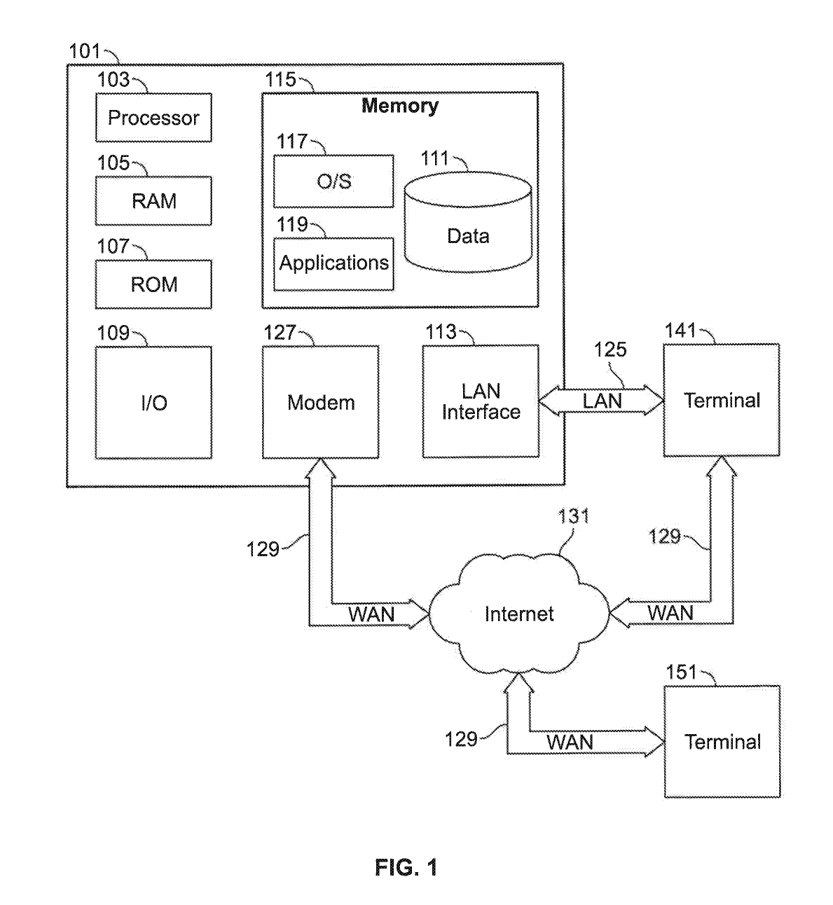

FIG. 1 is a block diagram that illustrates an exemplary computing device 101 (hereinafter, in the alternative, “server”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touchscreen, fingerprint reader, biometric scanner, barcode scanner, QR Code scanner, camera and/or stylus through which a user of device 101 may provide input, and, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown).

Application programs 119 used by server 101 may contain, according to an illustrative embodiment of the invention, computer executable instructions for implementing Smart Queuing. Additionally, application program 119 used by server 101, according to an illustrative embodiment of the invention, may include computer executable instructions for invoking user functionality related to communication, such as email, short message service (SMS), and voice input and speech recognition applications.

Database 111 used by server 101 may provide, according to an illustrative embodiment of the invention, centralized storage of the information comprising entity customer accounts/instruments databases, entity customer identification databases, service-selection and detail/parameter-settings databases and/or databases of LIs, facilitating interoperability of Smart Queuing between different elements of the entity residing at different physical locations. Alternatively and/or additionally database 111 may be distributed over different elements of the entity.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 may be connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to retrieve web pages from a web-based server. Any of various conventional web browsers may be used to display and manipulate data on web pages.

Server 101, according to an illustrative embodiment of the invention, may implement Smart Queuing as a process or set of processes within server 101 and/or distributed over one or more remote network-linked computers, such as terminals 141 and 151.

Computing device 101 and/or terminals 141 or 151 may also be mobile devices that may include various other components, such as a battery, speaker, scanner and antennas (not shown).

Computing device 101 and/or terminals 141 or 151 may represent computers of diverse divisions, departments, branches, affiliates and/or other elements of the entity. Data to be received, retrieved, aggregated and/or processed in implementing Smart Queuing may be resident at such divisions, departments, branches, affiliates and/or other elements of the entity.

Computing device 101 and/or terminals 141 or 151 may be used by the entity to advertise Smart Queuing services. Such advertisement may take the form of a screen-saver on a screen of terminal 141, which may, for example, represent a customer-accessible computer in a brick-and-mortar branch of the entity. Such advertisement may take the form of an entity-sent message attached to an OLB transaction transacted on terminal 151, which may, for example, represent a home-computer or mobile device of an entity-customer. Terminals 141 and/or 151 may be used by entity customers to access Smart Queuing services and/or to implement Smart Queuing functions.

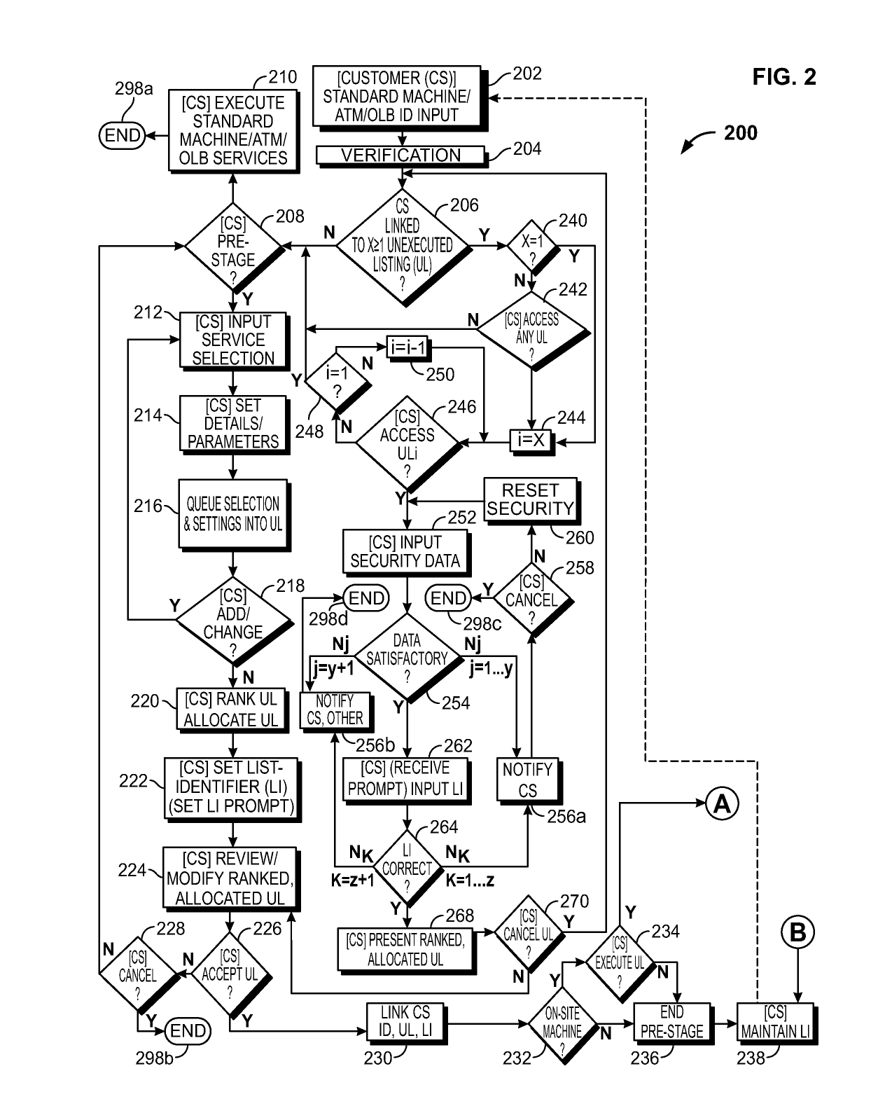

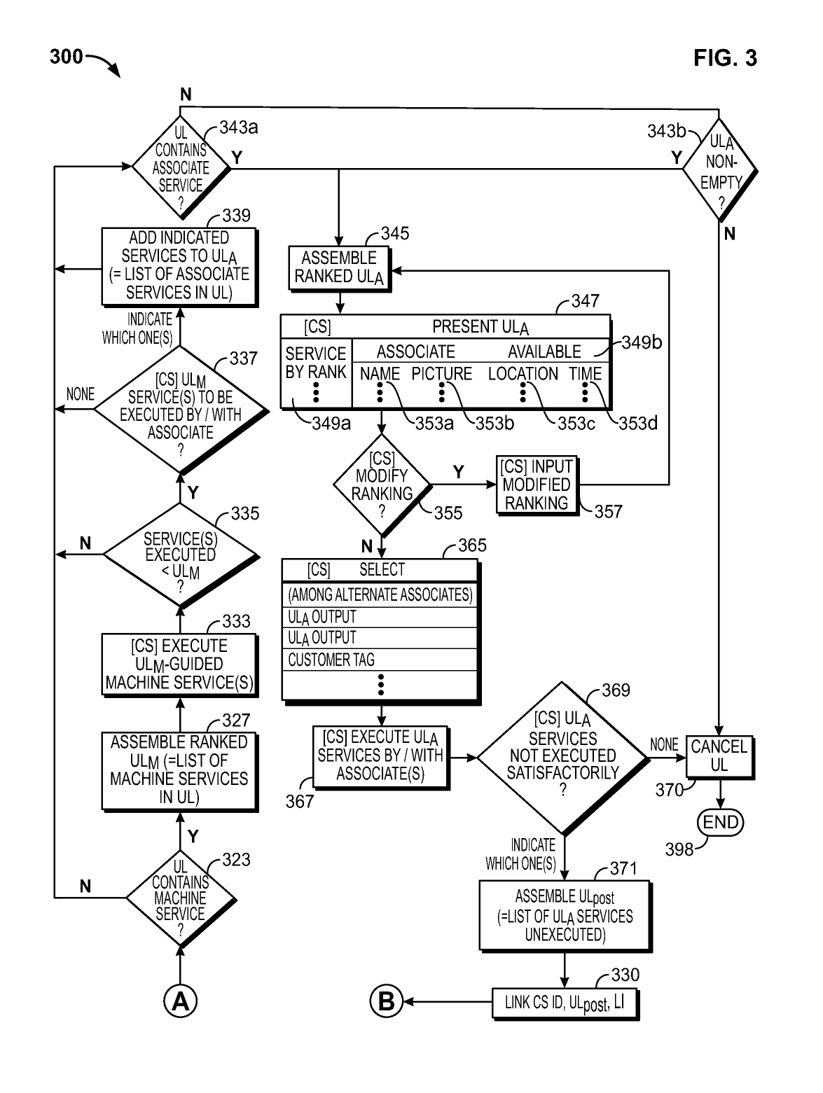

FIGS. 2 and 3 show illustrative processes 200 and 300, respectively, for providing Smart Queuing in accordance with the principles of the invention. Processes in accordance with the principles of the invention may include one or more features of the processes illustrated in FIG. 2 and/or FIG. 3.

For the sake of illustration, steps of the illustrated processes will be described as being performed by a “system.” Such system may include one or more of the features of the apparatus shown in FIG. 1 and/or of any other suitable device or approach. The system may be provided by the entity providing Smart Queuing functions of the invention or by any other suitable individual, organization or modality.

A step in FIG. 2 or 3 may involve system interactivity with an entity customer. A step may, e.g., present output to, and/or accept input from, the customer. Such a step may be marked “Customer (CS)” in square brackets or “CS” in square brackets, and may be hereinafter designated a [CS]-step. At a [CS]-step, the system may provide input/output means for input from, and/or output to, the customer. At a [CS]-step, the system may output a guideline, instruction, menu, option and/or prompt for presentation to the customer; such presentation may facilitate and/or solicit a selection and/or input from the customer. At a [CS]-step, the system may output a response to a selection/input from the customer. At a [CS]-step, the system may await, accept, evaluate, reject, register and/or respond to a selection/input from the customer.

At a [CS]-step of process 200 or process 300, the system may present the customer, in addition to other options that may be presented, an option of cancelling the step and/or the process (even if the [CS]-step may not be depicted in FIGS. 2 and 3 as branching to an “END” step).

The customer may signal opting to cancel the step and/or the process being performed. The customer may signal opting to cancel the step and/or the process through selecting/inputting such cancellation. The customer may signal opting to cancel the step and/or the process through departing from an area proximal to the system-provided means for input/output, and/or through failing to select/input within a system-set time interval.

In response to the customer signaling opting to cancel the step and/or the process, the system may cancel the step and/or the process.

The order of performance and/or description of steps of the processes in FIGS. 2 and 3 is illustrative only. Each of the described steps need not be completed in the illustrated order or at all.

The following descriptions of processes 200 and 300 in FIG. 2 and FIG. 3, respectively, are dividing into sections. The sections are PRODUCING A UL, ADDING A UL, ACCESSING A UL and EXECUTING A UL.

### Producing a UL

As may be depicted in FIG. 2, at step 202, the system may provide a customer, CS, with means to securely carry out banking activities. The means may or may not be on site at an entity site of service-execution. The means may include the proximal presence of an entity associate; the non-proximal presence of an entity associate through video teller methods/apparatus and/or video banking methods/apparatus; an entity machine, which may or may not be ATM-like in functioning, dedicated to Smart Queuing; an ATM configured for Smart Queuing; an OLB portal supporting Smart Queuing and/or a mobile banking modality supporting Smart Queuing; and/or any other suitable means of carrying out banking activities inclusive of Smart Queuing activities. Other suitable means may include an entity computer and/or a non-entity computer that supports, and may or may not be dedicated to, Smart Queuing.

At step 202, the system may start a session of process 200 upon CS accessing capabilities of the means provided for carrying out banking activities. To access the capabilities of the means to carry out banking activities, CS may input customer-ID information. The input(s) may include standard customer-ID information. The standard customer-ID information may include information encoded on a banking card and/or in an electronic device; a PIN; an answer to a security question; an article of personal identification; a value of a biometric reading; and/or any other suitable information identifying the customer.

At step 204, the system may subject the customer-ID information inputted in step 202 to standard verification processing that may include comparison of the inputted customer-ID information to entity-databased customer-ID information. If verification fails, the system may follow standard protocols of notifying the customer; instructing the customer to re-input customer-ID information; notifying an entity functionality; notifying a law enforcement authority; flagging the inputted information for investigation; invalidating the inputted information; shutting down the means provided at step 202; and/or any other suitable responses to failure of verification. Other suitable responses may include ending CS's session of process 200.

For purposes of further describing process 200 illustrated in FIG. 2, it may be that, at step 204, the system verifies the customer-ID information input by CS at step 202. The system may proceed to step 206.

At step 206, the system may check CS's verified customer-ID information relative to databased and/or otherwise stored, retained, accessible and/or retrievable Smart Queuing information. The system may check for linkage of CS's verified customer-ID information with one or more unexecuted Smart Queuing listings of pre-staged entity service-executions. The system may check for the number of such linkages. The number of such linkages may equal the number of Smart Queuing listings of pre-staged entity service-executions. This checking is depicted at step 206 as testing for the number of such linkages as being any number, “x,” that is greater than or equal to 1.

The system may link a Smart Queuing listing with customer-ID information of a customer that may use the system to produce and/or to access the listing. The system may maintain in an entity database a linkage of a listing with a customer. The listing linked with the customer may be designated as being unexecuted as long as a listed pre-staged valid service remains to be executed. Validity of a service may be set by the entity; by regulatory authorities; by status of an account and/or the customer; by hour/site considerations; and/or by any other suitable considerations. Other suitable considerations may include impact of local, regional and/or national states of emergency.

The customer and/or the entity may invalidate a listed unexecuted service and/or may remove an unexecuted service from a listing. The customer and/or the entity may cancel a listing containing one or more unexecuted services.

CS signaling opting to cancel a [CS]-step and/or to cancel process 200 or process 300, may result in the system invalidating a listed unexecuted service; in removing an unexecuted service from a listing; and/or in cancelling a listing. If CS may signal opting for cancellation of CS's session of process 200, the system may delete and/or not store the session's data.

A listing may be cancelled upon all listed pre-staged valid services being executed and/or removed. The system may unlink a cancelled listing from its linkage in a database with customer-ID information. The system may maintain linkage of a cancelled listing with the customer-ID information, but may designate the cancelled listing as no longer unexecuted. The system may remove a cancelled listing from the database.

At step 206, the system may check for CS's verified customer-ID information being linked to unexecuted Smart Queuing listings of pre-staged entity service-executions. This checking is depicted at step 206 as testing for the number of such linkages, represented by “x,” being greater than or equal to 1. If the number “x” is not greater than or equal to 1, the number “x” may be 0. If the number “x” is 0, CS's verified customer-ID information may not be currently linked with any unexecuted Smart Queuing listings.

At step 206, the system may determine that CS's verified customer-ID information may not be currently linked with any unexecuted Smart Queuing listings. CS may have produced one or more Smart Queuing listings, but, at some point prior to step 206, CS and/or the entity may have executed, invalidated and/or removed all pre-staged listed services. At some point prior to step 206, CS and/or the entity may have designated CS's listings as no longer unexecuted and/or may have cancelled CS's listings. CS may never have produced a Smart Queuing listing.

If the system determines that CS may not be linked to any unexecuted Smart Queuing listings, the system may proceed to step 208. At step 208, the system may offer CS the options of pre-staging one or more entity service-executions via Smart Queuing, or of in-session execution of one or more non-pre-staged standard entity services available at least via the means provided at step 202.

At step 208, CS may not opt for pre-staging of a service-execution. The system may proceed to step 210.

At step 210, the system may offer CS non-pre-staged, in-session execution of standard entity services available at least via the means provided at step 202. CS may opt for non-pre-staged, in-session execution of one or more standard entity services. For example, at step 210, if the means provided by step 202 may be an ATM-like apparatus, CS may opt for making a non-pre-staged, in-session cash withdrawal while CS is proximal to the ATM-like apparatus.

At step 210, upon CS completing in-session execution of standard entity services, and/or upon CS signaling opting to end the step and/or CS's session of the process, the system may proceed to Step 298a. The system may automatically proceed to Step 298a upon CS completing in-session execution of non-pre-staged standard entity services. At step 298a, the system may end CS's session of process 200.

If, at step 208, CS may opt for pre-staging one or more entity service-executions via Smart Queuing, the system may proceed to step 212.

At step 212, the system may present a menu of entity service-executions available for pre-staging. The system may present the services in a fashion based upon CS's history of pre-staging service-executions and/or upon CS's history of execution of non-pre-staged entity services. The system may present the services in a fashion based upon entity resources available through the means of step 202. The system may present the services in a fashion based upon entity resources available through entity functionalities accessible and/or pre-stageable through Smart Queuing.

At step 212, CS may select and/or input a service-execution from the menu. CS may input a service-execution independent of a menu. For example, CS may select/input a deposit to be pre-staged. The system may present options of reviewing, modifying and/or accepting the selection/input. If CS may opt to modify the selection/input, the system may present options of selecting/inputting an alternate service-execution. CS may, for example, select/input a withdrawal to be pre-staged or may again select/input a deposit to be pre-stage. If CS may accept a selected/inputted service-execution to be pre-staged, the system may proceed to step 214.

At step 214, the system may present CS a menu of details/parameters which may be set in relation to the accepted selection/input of step 212. The system may present the menu in a fashion based upon CS's history of setting details/parameters of the service-execution selected/inputted at step 212. The basis may be CS's history of pre-staging the selected/inputted entity service-execution and/or of executing the entity service. The system may present the menu in a fashion based upon entity resources available through the means of step 202. The system may present the menu in a fashion based upon entity resources available through entity functionalities accessible and/or pre-stageable through Smart Queuing.

For example, if the accepted selection/input of step 212 may have been a business consultation meeting with an entity associate, at step 214 the system may present a menu of categories of business specialization of various entity associates available at various brick-and-mortar entity branches; the names of the entity associates; their branch locations; and/or their days and/or hours of availability. If CS may have a history of meeting with any of several particular business specialists at specific brick-and-mortar entity branches, the system presentation may highlight the specific entity branches, the particular entity associates and the associates' approximate timeslots of near-term to mid-term availability. If CS may have a history of meeting those entity associates on the first Tuesday of each month, the presentation may highlight the next such date.

As another example, if the accepted selection/input of step 212 may have been a cash withdrawal, at step 214 the system may present a menu of CS's entity accounts from which the cash may be withdrawn. After CS's selection of an account, the system may present cash withdrawal amounts, and may highlight a menu-selection showing an amount that CS may have most recently withdrawn from the account, and/or that CS may have previously withdrawn from the account close to the same day of the month and/or at the same site.

Following the cash withdrawal example, if the means provided at step 202 may be an ATM, the system may present menus of CS's accounts and of cash withdrawal amounts, and may highlight a cash withdrawal menu-selection showing an amount rounded up from an amount that CS may have previously withdrawn at the same site and close to the same day of the month by withdrawal from the selected account through a proximal teller. The amount of the previous withdrawal by CS may not be possible using only ATM-available bill denominations. The highlighted amount on the system-presented menu may be the closest amount greater than the previous withdrawal that may be possible using only ATM-available bill denominations.

At step 214, CS may select and/or input from menu(s) one or more details/parameters in relation to the service-execution selected/inputted at step 212. CS may select a detail/parameter highlighted on the menu(s). CS may input independent of menu(s) a detail/parameter in relation to the service-execution. For example, the accepted service-execution selected/inputted at step 212 for pre-staging may have been a cash withdrawal; at step 214, CS may select/input detail/parameter-settings of the withdrawal as an amount of $500 to be withdrawn from a particular account.

At step 214, the system may present options of reviewing, modifying and/or accepting selections/inputs. If CS may opt to modify the selected/inputted detail/parameter-settings of the service-execution to be pre-staged, the system may present options of selecting/inputting alternate detail/parameter-settings. Following the above example of an initial $500 withdrawal selection/input, CS may, for example, alternatively select/input $600 to be withdrawn from a different account. If CS may accept selected/inputted detail/parameter-settings of the service-execution to be pre-staged, the system may proceed to step 216.

At step 216, the system may queue the selection/input of step 212, together with the selection(s)/input(s) of step 214, into a UL. The system may proceed to step 218.

At step 218, the system may present the UL to CS, with options of accepting the UL or of adjusting the UL by adding and/or changing service-execution(s) and/or related detail/parameter-settings. If CS may opt to adjust the UL of selections/inputs of steps 212 and 214, the system may return to step 212, where the menu of service-executions may feature the previously accepted service-execution highlighted. CS may select/input a service-execution other than the highlighted one. CS may select the highlighted service-execution. After reviewing the new step 212 selection/input, CS may accept the selection/input and the system may proceed to step 214. At step 214, CS may select/input detail/parameter-settings of the new service-execution selection/input of step 212. After reviewing the new step 214 selection/input, CS may accept the selection/input and the system may proceed again to step 216. At step 216, the system may queue the new selections/inputs of steps 212 and 214 into the UL. The system may proceed again to step 218 from which CS may choose to adjust the UL by another pass through steps 212, 214, 216 and 218; or to accept the UL.

Multiple passes through steps 212, 214, 216 and 218 may result in the UL comprising several service-selections and their related detail/parameter-settings. The listed service-selections may be different from each other; two or more of them may be identical. Identical listed service-selections may have different detail/parameter-settings. For example, two deposits may be in a UL; the deposits in the UL may be for the same amount, but to two different accounts; or the deposits may be for the same amount to the same account, but scheduled for two different dates.

A given pass after the first pass through steps 212, 214, 216 and 218 may result in a listed service-selection and its related details/parameters-settings exactly identical to one already listed; the system may present CS with the option of removing one of them, and/or of returning to step 212 to review/modify one or both.

If, at step 218, CS chooses to accept the UL, the system may proceed to step 220.

At step 220, the system may rank and/or allocate the service-execution selection/inputs in the UL. Ranking/allocation processes may separate pre-staged service-executions by expected/forecast dates of execution and/or other time-sensitive considerations specified in detail/parameter-settings; by need of a service-execution (either inherent in the entity service or specified in its detail/parameter-settings) for an entity associate or a particular type of entity machine; by accumulation and/or aggregation of similar service-executions; and/or by other suitable considerations. Other suitable considerations may include avoidance of account-depletion and/or avoidance of overdraft charges.

Ranking/allocating processes may convert a queue of pre-staged service-executions of a raw UL built through multiple passes through steps 212, 214, 216 and 218, into an efficiently ordered pre-execution UL that may optimize entity resources and may minimize CS's on-site time and/or effort for service-execution. Ranking/allocating processes may, for example, convert a raw UL containing a plurality of pre-staged service-executions involving several accounts of CS, into a pre-execution UL featuring the service-executions sequenced first by those with specified dates of execution and those carrying no specified date; within a given date of execution, between machine-executable and entity-executable; within those categories, on the basis of type of service-execution, such as deposits before withdrawals.

At step 220, the system may invoke entity rules for ranking/allocation and/or may present CS with ranking/allocation selection/input options. A UL containing only a single service-selection and its related details/parameters-settings may be subject to allocation of the service-selection. From step 220, the system may proceed to step 222.

At step 222, the system may present CS with selection/input options for choosing a LI to be linked with the UL. CS may select/input the LI. The system may present CS with selection/input options for choosing one or more prompts that may serve to as reminders of the LI selected/inputted. CS may select/input prompt(s). Prompt(s) may be optional; a LI may be linked to customer-ID without a prompt associated with the LI. From step 222, the system may proceed to step 224.

At step 224, the system may present CS with selection/input options for reviewing/modifying features of the UL. Features of the UL may include a service-selection; a detail/parameter-setting; a ranking and/or allocation of a service-selection and other suitable features. Other suitable features may include the LI and/or prompt(s). CS's review/modification may be subject to automatic review/modification based upon entity rules. From step 224, the system may proceed to step 226.

At step 226, the system may present CS with options of accepting or not accepting the reviewed/modified ranked and allocated UL with which step 224 concluded. If CS opts not to accept the UL, the system may not store the UL, the LI or any prompt(s); the system may proceed to step 228.

At step 228, the system may present CS with options of cancelling or not cancelling CS's Smart Queuing session. If CS opts to cancel the Smart Queuing session, the system may proceed to step 298b. At step 298b, the system may end CS's Smart Queuing session.

If, at step 228, CS opts not to end CS's Smart Queuing session, the system may return to step 208. At step 208, CS may opt not to pre-stage any service-selections; the system may proceed to step 210; at 210, CS may execute non-pre-staged, standard entity services; the system may then proceed to, and end the session at, step 298a. At step 208, CS may opt to pre-stage service-selections; the system may return to passing through steps 212, 214, 216 and 218, and then through steps 220, 222, 224 and 226, as described above. At step 226, CS may accept the UL produced in one or more passes through steps 212, 214, 216 and 218, and then ranked/allocated at step 220 and reviewed/modified at step 224.

If, at step 226, CS opts to accept the UL, the system may store the UL, the LI and any prompt(s); the system may proceed to step 230.

At step 230, the system may link entity customer-ID information identifying CS together with the UL, the LI and the prompt. The CS's entity customer-ID information, the UL, the LI and any prompt(s) may be linked together in conjunction with entity databases. From step 230, the system may proceed to step 232.

At step 232, the system may determine whether the means provided at step 202 for Smart Queuing may be an on-site machine, such as an entity computer dedicated to Smart Queuing located at a brick-and-mortar entity branch, or an entity ATM configured to support Smart Queuing not located at a brick-and-mortar entity branch but located in some other secure site. If the means provided at step 202 for Smart Queuing may not be an on-site machine (the means provided at step 202 may be, e.g., an OLB portal accessed through CS's tablet), the system may proceed to step 236.

If the means provided at step 202 for Smart Queuing may be an on-site machine, the system may proceed to step 234. At step 234, the system may present CS with the options of executing or not executing on-site one or more of the pre-staged service-executions queued into the UL. If CS opts to execute on-site one or more of the pre-staged service-executions queued into the UL, the system may proceed to point A (circled), from which the system may proceed to process 300 illustrated in FIG. 3 and described below in the detailed description of FIG. 3. If, at step 234, CS opts not to execute the UL, the system may proceed to step 236.

At step 236, the system may end processes of pre-staging entity service-executions associated with the UL. From step 236, the system may proceed to step 238.

At step 238, the LI linked to the prompt(s), to the UL and to CS's customer-ID may be conveyed to CS. An LI may also be conveyed to CS from point B (circled); the system may proceed to point B (circled) from process 300 (described below in the detailed description of FIG. 3).

At step 238, CS may maintain the LI through CS's choice of means; the means may have been selected/inputted as a part of selection (step 222) and/or modification (step 224) of the LI. Such means may include storage in electronic memory, and commitment to personal memory and/or to paper. CS may not maintain the LI; CS may rely on the system's storage and future presentation of the prompt to remind CS of the LI when CS may wish to access the UL.

### Adding a UL

From step 238, CS has the option of returning to step 202 to produce another UL. From step 238, CS has the option of returning to step 202 to access the previous UL. Accessing the previous UL may allow CS to cancel the previous UL. Accessing the previous UL may allow CS to modify the previous UL and/or to execute the previous UL.

In returning to step 202, CS may input customer-ID. If CS may not have signaled closing CS's Smart Queuing session at the means provided at step 202 in the production of the previous UL (if CS is continuing a Smart Queuing session at, e.g., an ATM), the system may not require another input of customer-ID. The system may proceed to step 204 and, given verification of customer-ID, to step 206.

At step 206, since CS's customer-ID may be linked to the previous UL, the system may determine that CS's customer-ID may be linked to a number “x” of ULs equal to or greater than 1. The condition of step 206 (x≧1) having been met, the system may proceed to step 240.

At step 240, the system may determine if the number of ULs linked to CS's customer-ID, “x”, may be equal to 1. In the case of the previous UL being the only UL linked to CS's customer-ID, the condition x=1 may be met and the system may proceed to step 244. At step 244, an index “i” is set to the value of “x”; in the case of the previous UL being the only UL linked to CS's customer-ID, “i” would be set to 1 and the system may proceed to step 246.

At step 246, CS may be presented with options of accessing or not accessing a UL; the UL is symbolized in FIG. 2 by ULᵢ, a UL bearing the index “i.” In the case of the previous UL being the only UL linked to CS's customer-ID, the UL that CS is presented with options of accessing or not accessing would be given by “UL₁”; “UL₁” may symbolize the 1^{st} and, in this case, the only UL linked to CS's customer-ID, i.e., the previous UL. If CS opts not to access UL₁, the system may proceed to step 248. At step 248, the system may test for the condition i=1. In the case of CS opting not to access UL₁, the condition i=1 would be met and the system may proceed to step 208. At step 208, CS may opt not to pre-stage service-executions, and the system would proceed to step 210, at which step CS may execute non-pre-staged services and/or end the session, as described above in the section PRODUCING A UL.

At step 208, CS may opt to pre-stage service-executions and the system may proceed to and through steps 212, 214, 216 and 218, and then to and through steps 220, 222 and 224 to arrive at step 226, as described above in relation to production of the previous UL; on this return of CS to process 200, having passed through steps 212-226, CS may be presented with a new UL, LI and prompt(s) to accept or not accept at step 226; if CS accepts the new UL, LI and optional prompt at step 226, the system may proceed to and through step 230, at which step the new UL, LI and optional prompt may be linked with CS's customer-ID; the system may proceed to step 232, from which step, if the means provided at step 202 is not an on-site machine or if CS opts not to execute the new UL via the on-site machine provided, the system may proceed through step 236 to step 238, as described above at the end of the section ADDING A UL; at step 238, CS may be presented with the new LI.

CS may return to step 202 to add or access ULs. On returning to and through steps 202 and 204 to arrive at step 206, CS, with customer-ID linked to two ULs (the new UL and the previous UL), would be processed differently from previously. At step 206, with the test condition of x≧1 being met by customer-ID linked to 2 ULs (x=2), the system would proceed to step 240, from which step the system may proceed to step 242 since the condition of step 240 (x=1) would not be met. At step 242, CS may be presented with options of accessing any of CS's ULs.

If CS opts not to access any of CS's ULs, the system may proceed to step 208.

If, at step 242, CS opts to access any of CS's ULs, the system may proceed to step 244. At step 244, the system may set the index “i” to the value of “x” of ULs linked to CS's customer-ID; in a case of x=2, “i” would be set to 2. The system may proceed to step 246 and present CS with options of accessing or not accessing “UL₂”, which may symbolize the new UL if the indexing may be keyed to recency of ULs. If CS opts not to access UL₂, the system may proceed to step 248. At step 248, with index “i” set to the value of “x” that equals 2 in the case of two ULs linked with CS's customer-ID, the condition i=1 would not be met; the system may proceed to step 250, at which step the index “i” is reset by reduction in value by 1 (i=i−1) and the system may return to step 246. At step 246, with the reset index “i” in the case of two ULs linked to CS's customer ID now being equal to 1, CS may be presented with options of accessing or not accessing “UL₁”, which may symbolize the previous UL. If CS opts not to access UL₁, the system may proceed to step 248. At step 248, with reset index “i” set to 1 in the case of two ULs linked with CS's customer-ID, the condition i=1 would be met; the system may proceed to step 208.

From step 208, CS may use Smart Queuing to proceed again to and through step 212 to step 238. CS may add one UL to those linked to CS's customer-ID by means of each subsequent pass from step 202 to step 238.

### Accessing a UL

From step 238, CS, with at least one UL linked to CS's customer-ID, may return to step 202 and, by the input of customer-ID, as above, be passed through step 204 to step 206. At step 206, the condition x≧1 being met due to the UL(s) linked to CS's customer-ID, the system may proceed to step 240.

If CS has two ULs linked to CS's customer-ID but may wish to access the first-produced of the two, the system would proceed from step 240 through step 242 to step 244, at which step the index “i” may be set to 2 and the system may proceed to step 246. At step 246, the system may present CS with options of accessing or not accessing “UL₂”, which may symbolize the second-produced of CS's two ULs. CS may opt not to access UL₂, and the system may proceed to step 248, at which step the condition x=1 would not be met and the system may proceed to step 250, at which step the index “i” may be reset from 2 to 1; the system may return to step 246, as described above in the section ADDING A UL, and may present CS with options of accessing or not accessing “UL₁”, which may symbolize the first-produced of CS's two ULs, the UL CS may wish to access.

At step 246, CS may opt to access the UL symbolized in FIG. 2 by “UL₁”; the system may proceed to step 252. At step 252, CS may input Smart Queuing security data. Such security data may be an answer to a security question, a value of a biometric feature (e.g., a fingerprint), and/or other suitable forms of security data. Other suitable forms of security data may include an identification code. A security level for step 252 may be set by the system. The security level may determine the required form of security input at step 252. The security level may be set such that no security input is required. From step 252, the system may proceed to step 254.

At step 254, the system may check the security data inputted at step 252 by comparison of the input with entity-databased information linked to CS's customer-ID. The system may check for satisfactory matching of the input with the databased information. The system may tolerate a number “y” of inputs of unsatisfactory inputs of data at step 252. The system may keep track of the number of unsatisfactory inputs; the number of unsatisfactory inputs may be recorded as an index “j” that may start at 0 before any unsatisfactory inputs, may be set to 1 with the first unsatisfactory input and may increase by 1 for each additional unsatisfactory input. An unsatisfactory input may be registered by the system as “Nⱼ”, with the index “j” corresponding to the number of unsatisfactory step 252 inputs.

For example, the system setting of “y” may be 1. If CS makes a first security data input at step 252 that is deemed unsatisfactory at step 254, the system may register that first unsatisfactory input as “N₁”; the system may follow a course of action represented in FIG. 2 by the decision branch-line from 254 labeled “Nⱼ” above the line and labeled “j=1 . . . y” below the line. The notation “j=1 . . . y” may indicate that the index “j” of the Nⱼ unsatisfactory security input may be 1 and may go no higher than the value of “y”, which in this example is 1. Following the represented course of action, the system may proceed to step 256a. At step 256a, CS may be notified that the security data input was unsatisfactory. CS may be notified by the means provided at step 202. (A notification may be transmitted to a communication device of the customer identified by the customer-ID verified at step 204. Thus, if stolen or lost customer-ID was used to pass through step 204 verification, the entity customer database-linked to the customer-ID may be notified of fraudulent use of the customer-ID.) From step 256a, the system may proceed to step 258.

Continuing the example of a first unsatisfactory step 252 input, at step 258 the system may present CS options of cancelling accessing the UL or of performing another security data input. If CS opts for cancelling accessing the UL, the system may proceed to step 298c; at step 298c, the system may end CS's Smart Queuing session. If, at step 258, CS opts for another security data input, the system may proceed to step 260; at step 260, the system may reset the security level that may determine the required form of security input at step 252. The reset security level may be the same as previously used at step 252. The reset security level may require a more secure form of security data input than previously used at step 252.

At step 252, CS may once again input Smart Queuing security data. The form of the required input may be determined by the reset security level. The system may proceed to step 254. If the system evaluates CS's second security data input as unsatisfactory, the system may increase the index “j” to match the number of unsatisfactory step 252 inputs and may register that second unsatisfactory input as “N₂”. The system may not follow the course of action represented in FIG. 2 as the branch-line from 254 labeled “Nⱼ” above the line and labeled “j=1 . . . y” below the line, because the value of 2 of the index “j” is greater than this example's “y” of 1. Instead, since the value of the index “j” of the second unsatisfactory step 252 input, 2, is equal in this example to the value of y+1, the system may follow a course of action represented in FIG. 2 as the branch-line from 254 labeled “Nⱼ” above the line and labeled “j=y+1” below the line. Following the represented course of action, the system may proceed to step 256b. At step 256b, CS may be notified that the second security data input was found unsatisfactory; CS may be notified that the number of unsatisfactory security inputs exceeded the number of system-tolerated unsatisfactory security inputs; CS may be notified that CS's Smart Queuing session will be ended. Means of notification may be the means of notification used for CS's session's previous unsatisfactory security input(s). Other may be notified of the number of unsatisfactory security inputs exceeding the number of system-tolerated unsatisfactory security inputs; others may be notified of an attempted security breach via the Smart Queuing means provided at step 202. Others may include entity representatives and other suitable security representatives. Other suitable security representatives may include law enforcement authorities.

From step 256b, the system may proceed to step 298d; the system may end CS's Smart Queuing session at step 298d.

The value of the system-set limit “y” of the number of system-tolerated step 252 unsatisfactory inputs may be greater than the above example's value of 1.

If a step 252 security input of CS is evaluated at step 254 as satisfactory before the number of unsatisfactory inputs exceeds the system-set limit “y”, the system may reset the index “j” to 0 and may proceed to step 262.

At step 262, the system may present the UL-linked prompt(s) to CS. There may be more than one prompt for CS to choose from. CS may use the prompt to remember the UL-linked LI. At step 262, CS may make a LI input. The LI input may be made by CS via an electronic device of CS. The LI input may made by CS by submitting a biometric feature of CS for evaluation. The LI input may be made by CS by alphanumeric input at a keyboard, touch screen and/or other suitable methodologies and/or apparatus provided and/or supported by the means of step 202. Suitability of methodologies and/or apparatus for LI input may depend on the nature of the UL-linked LI.

From step 262, the system may proceed to step 264. At step 264, the system may check the LI input for correctness. The system may check the LI inputted at step 262 by comparison of the input with UL-linked LI information stored in conjunction with entity databases. The system may check for correct matching of the LI input with the databased information. The system may tolerate a number “z” of inputs of incorrect LI inputs at step 262. The system may keep track of the number of incorrect LI inputs; the number of unsatisfactory inputs number may be recorded as an index “k” that may start at 0 before any incorrect LI inputs, may be set to 1 at the first incorrect LI input and may increase by 1 for each additional incorrect LI input. An incorrect LI input may be registered by the system as “Nₖ”, with the index “k” corresponding to the number of incorrect step 262 LI inputs.

For example, the system setting of “z” may be 1. If CS makes a first LI input at step 262 that is evaluated at step 264 as incorrect, the system may register that first incorrect LI input as “N₁”; the system may follow a course of action represented in FIG. 2 by the decision branch-line from 264 labeled “Nₖ” above the line and labeled “k=1 . . . z” below the line. The notation “k=1 . . . z” may indicate that the index “k” of the Nₖ incorrect LI input may be 1 and may go no higher than the value of “z”, which in this example is 1. Following the represented course of action, the system may proceed to step 256a. At step 256a, CS may be notified that the LI data input was incorrect. CS may be notified by the means provided at step 202. (A notification may be transmitted to a communication device of the customer identified by the customer-ID verified at step 204.) From step 256a, the system may proceed to step 258.

Continuing the example of a first incorrect step 262 LI input, at step 258 the system may present CS options of cancelling accessing the UL or of performing another security data input and LI input. If CS opts for cancelling accessing the UL, the system may proceed to step 298c; at step 298c, the system may end CS's Smart Queuing session. If, at step 258, CS opts for another security data input and LI input, the system may proceed to step 260; at step 260, the system may reset the security level that may determine the required form of security input at step 252. The reset security level may be the same as the security level used at the satisfactory step 252 security data input that brought CS to the step 262 LI input. The reset security level may call for a more secure form of security data input than that used at the satisfactory step 252 security data input that brought CS to the step 262 LI input.

At step 252, CS may once again input Smart Queuing security data. The form of the required input may be determined by the reset security level. The system may proceed to step 254. For the sake of efficient presentation of the example of a first LI input being incorrect, it may be assumed that CS's second security data input may be satisfactory; the system may proceed to step 262, at which step CS may input a second LI input. If the second LI input is deemed incorrect at step 264, the system may increase the index “k” to match the number of incorrect step 262 LI inputs and may register that second incorrect LI input as “N₂”. The system may not follow the course of action represented in FIG. 2 by the decision branch-line from 264 labeled “Nₖ” above the line and labeled “k=1 . . . z” below the line, because the value of 2 of the index “k” is greater than this example's “z” of 1. Instead, since the value of the index “k” of the second incorrect step 262 LI input, 2, is equal in this example to the value of z+1, the system may follow a course of action represented in FIG. 2 as the branch-line from 264 labeled “Nₖ” above the line and labeled “k=z+1” below the line. Following the represented course of action, the system may proceed to step 256b. At step 256b, CS may be notified that the second LI input was deemed incorrect; CS may be notified that the number of incorrect LI inputs exceeded the number of system-tolerated incorrect LI inputs; CS may be notified that CS's Smart Queuing session will be ended. Means of notification may be the means of notification used for CS's session's previous incorrect LI input(s). Others may be notified, as in the example above of unsatisfactory security inputs exceeding the number of system-tolerated unsatisfactory security inputs.

From step 256b, the system may proceed to step 298d; the system may end CS's Smart Queuing session at step 298d.

The value of the system-set limit “z” of the number of system-tolerated step 262 incorrect LI inputs may be greater than the value of 1.

If a step 262 LI input of CS is evaluated at step 264 as correct before the number of incorrect LI inputs exceeds the system-set limit “z”, the system may grant access to the UL, may reset the index “k” to 0, and may proceed to step 268.

At step 268, the system may present the UL to CS. At step 268, CS may review the presentation of the UL. From step 268, the system may proceed to step 270.

At step 270, the system may present CS with options of cancelling the UL or of not cancelling the UL. If CS opts to cancel the UL, the system may adjust the status of the UL. If CS opts to cancel the UL, the system may remove the UL from its linkage with CS's customer-ID; the system may remove the UL from entity databases; and/or the system may designate the listing as no longer being an unexecuted listing. If CS opts for cancellation at step 270, the value of the number “x” of ULs linked with CS's customer-ID may be reduced by one. If CS opts for cancellation at step 270, the system may return to step 206 and test the number “x” of ULs linked to CS's customer-ID for the condition x≧1. From step 206, CS may access ULs, add new ULs, execute non-pre-staged service-executions and/or cancel CS's session, depending on the number “x” of ULs linked to CS's customer-ID, and depending on CS's selection/inputs at various [CS]-steps encountered after step 206, as described above in this and previous sections.

If, at step 270, CS opts not to cancel the UL presented at 268, the system may mark the UL as having been presented to CS at step 268 and may proceed to step 224, at which step CS and/or the entity may review and/or modify features of the UL, as described above in earlier descriptions of step 224. From step 224, the system may proceed to step 226, at which step the system may present CS options of accepting the post-review/modification UL of step 224, or of not accepting the post-review/modification UL. If, at step 226, CS opts not to accept the UL, the system may change the status of the listing from being designated a UL and/or may remove the listing from linkage with CS's customer-ID and/or from entity databases, reducing the value of the number “x” of ULs linked with CS's customer-ID by one. From step 226, the system may proceed to step 228, from which step the system and CS's Smart Queuing session may proceed as described above in earlier descriptions of step 228 and subsequent steps.

If, at step 226, CS opts to accept the post-review/modification UL, the system may proceed through step 230 and to step 232 as described above in earlier descriptions of those steps. If the means provided at step 202 is determined at step 232 to not be an entity machine, the system may proceed through step 236 to step 238 as described above in earlier descriptions of those steps; if the means provided at step 202 is determined at step 232 to be an entity machine, the system may proceed through steps 234 and 236 to step 238 as described above in earlier descriptions of those steps, if CS opts at step 234 not to execute the UL.

If, as described above in earlier descriptions of step 234, CS opts to execute the UL at step 234, the system may proceed to point A (circled) from which the system may proceed to process 300 illustrated in FIG. 3.

### Executing a UL

As may be depicted in FIG. 3, the system may enter process 300 from point A (circled). The system may proceed to step 323. At step 323, the system may determine if the UL lists any service-executions allocated to execution by entity machine(s). If the system determines that the UL does not list any service-executions allocated to execution by entity machine(s), the system may proceed to step 343a. If, at step 323, the system determines that the UL does list at least one service-execution(s) allocated to machine-execution, the system may proceed to step 327.

At step 327, the system may assemble, from databased information of all service-executions listed in the UL, an unexecuted listing of all service-executions allocated to machine-execution. The unexecuted listing of all service-executions allocated to machine-execution (hereinafter, “UL_{M}”) may be ranked on the basis of rankings of machine-services in the UL.

The UL_{M} may be presented to CS at step 333, at which step CS may execute none, some, or all of UL_{M} service-executions via the entity machine provided at step 202 of FIG. 2. CS's execution of any of UL_{M} service-executions may be expedited by the components and functions of Smart Queuing. Upon CS completing CS's execution of none, some, or all of UL_{M} service-executions, the system may proceed to step 335.

At step 335, the system may determine if the number of service-execution executed at step 327 is less than the number of service-executions listed in UL_{M}. If the system determines that the number of service-execution executed at step 327 is not less than the number of service-executions listed in UL_{M} (i.e., all service-executions listed in UL_{M} were executed at step 327), the system may proceed to step 343a. If the system determines that the number of service-executions executed at step 327 is less than the number of service-executions listed in UL_{M} (i.e., not all service-executions listed in UL_{M} were executed at step 327), the system may proceed to step 337.

At step 337, the system may present CS with options of indicating which, if any, of the machine-services unexecuted at step 327 CS may want to have reallocated from service-execution by machine to service-execution by and/or with entity associates (hereinafter, a service-execution by and/or with entity associates may be designated an “associate-execution”). If CS may opt for none of the unexecuted machine-executions to be reallocated to associate-execution, the system may proceed to step 343a. If CS may indicate one or more of the unexecuted machine-executions to be reallocated to associate-execution(s), the system may proceed to step 339.

At step 339, the system may create an empty listing of associate-executions (hereinafter, a listing of associate-executions may be designated, in the alternative, a “UL_{A}”). The system may proceed to add service-executions to UL_{A}, populating the listing with all the indicated unexecuted machine-executions to be reallocated to associate-execution(s). From step 339, the system may proceed to step 343a.

At step 343a, the system may determine if the UL lists any associate-executions. If the system determines that the UL does not list any associate-executions, the system may proceed to step 343b. At step 343b, the system may determine if a UL_{A} exists and if that UL_{A} is not empty of listed service-executions. If the system determines that no UL_{A} exists or that the UL_{A} is empty, the system may proceed from step 343b to step 370; at step 370, the system may cancel the UL (with concomitant reduction of the value of the number “x” of ULs linked with CS's customer-ID) and may proceed to step 398; at step 398, the system may end CS's Smart Queuing session. If, at step 343b, the system determines that a UL_{A} exists and that the UL_{A} is not empty of listed service-executions, the system may proceed to step 345.

If, at step 343a, the system determines that the UL does list one or more associate-executions, the system may proceed to step 345.

At step 345, the system may create a UL_{A} if none exists (i.e., if there are no machine-executions indicated by CS at step 337 to be reallocated to be associate-services) and may proceed to add to the UL_{A}, populating the listing with all the associate-services listed in the UL; the system may adopt the populated listing as a complete UL_{A}. If there are no associate-services listed in the UL, the system may adopt the UL_{A} listing machine-executions indicated by CS to be reallocated to be associate-services, as a complete UL_{A}. If a UL_{A} listing machine-executions indicated by CS to be reallocated to be associate-services was produced at step 339 and there are associate-services listed in the UL, the system may combine the listings of both into a complete UL_{A}. The complete UL_{A} may list all the indicated services of step 339 and/or the associate-services listed in the UL. The complete UL_{A} may be ranked. Upon completing to assemble the complete UL_{A}, the system may proceed to step 347.

At step 347, the system may present to CS a representation of the completely assembled UL_{A}. CS may review the representation. At 349a, the representation may feature ranked service-executions. The ranked service-executions may include all the service-executions listed in the complete UL_{A}. The service-executions may be ranked on the basis of ranking of services in the UL. At 349b, the representation may feature a listing of available associates. Execution of a 349a service-execution by a 394b associate may performed by the associate for CS and/or together with CS. The system may match a particular associate to a particular service-execution on the basis an associate's expertise, availability and/or some other basis. Other basis for matching a particular associate to a particular service-execution may include detail/parameter-settings in UL.

The representation at step 347 may feature information relevant to a listed associate. At 353a, the information may include a name of a listed associate. At 353b, the information may include a picture of a listed associate. At 353c, the information may include the location of a listed associate. At 353d, the information may include time(s) of availability of a listed associate. The informational features shown at 353a, 353b, 353c and 353d may be presented for none, some or all of the listed associates. Different informational features may be presented for particular associates. The information relevant to associates may be sensitive to the ranking of the services, which may set a prioritized order-of-execution. From step 347, the system may proceed to step 355.

At step 355, the system may present CS an option of modifying the ranking of services listed in the complete UL_{A} represented at step 347. If CS opts to modify the ranking, the system may proceed to step 357. At step 357, CS may select/input modification(s) of the ranking. CS's modification(s) may be subject to entity-review/modification. From step 357, the system may proceed to step 345, at which step the system may assemble a new complete UL_{A} that may incorporate the ranking modification(s). The new complete UL_{A} may be different from the previous complete UL_{A}. The system may return to step 347, presenting CS a representation of the new complete UL_{A}, the representation presenting, among other features, ranked 349a service-executions. The system may proceed to step 355, presenting CS the option of modifying the ranking. If CS opts not to modify the ranking, the system may proceed to step 365.

At step 365, the system may present CS with a menu from which to select various options. The options may include choice(s) among associates that may be available in the same timeslot; choice(s) of multiple output formats for representations of the complete UL_{A} that may be output for CS (e.g., a hardcopy in hand, an electronic copy sent to a phone or portable device of CS); choice(s) of tags (e.g., CS's GPS-enabled phone, CS's portable device) by which associates may be able track CS; and/or other suitable choices of features. Other suitable choices of features may include choice(s) of means for alerting CS to updates on the UL_{A} information. From step 365, the system may proceed to step 367.

At step 367, CS may execute, via entity associates, none, some, or all of the service-executions listed in the complete UL_{A}. CS's execution via entity associates of any of those service-executions may be expedited by the components and functions of Smart Queuing. Upon CS completing CS's execution via entity associates of none, some, or all of service-executions listed in the complete UL_{A}, the system may proceed to step 369.

At step 369, the system may present CS with options of having the system assemble a new listing (to be designated “UL_{POST}”) of CS-selectable service-executions listed in the complete UL_{A}. Service-executions to be selected for listing in UL_{POST} may include service-executions listed in the complete UL_{A} that CS may deem to have not been executed satisfactorily, completely or at all at step 367.

CS may opt to make selections/inputs from those offered in step 369 to be listed in UL_{POST}. CS may input service-executions not listed in the complete UL_{A}. CS may reallocate service-executions to be listed in UL_{POST} between machine-execution and associate-execution. CS may select/input and/or review/modify the detail/parameter-settings of service-executions to be listed in UL_{POST}. CS may rank service-executions to be listed in UL_{POST}. CS may choose a LI for UL_{POST}. If CS does not choose a LI for UL_{POST}, the LI for UL_{POST} may be system-selected. The LI for UL_{POST} may be the LI of the UL. CS may select/input a LI prompt. When CS may complete CS's selections/inputs at step 369, the system may proceed to step 371.

At step 371, the system may assemble UL_{POST} incorporating CS's selections/inputs at step 369. The assembled UL_{POST} may be subject to review/modification by CS and/or by the entity. A reviewed/modified UL_{POST} may replace the assembled UL_{POST} as a final UL_{POST}. The assembled UL_{POST} may be the final UL_{POST}. From step 371, the system may proceed to step 330.

At step 330, the system may link CS's entity customer-ID information together with the final UL_{POST}, the LI and the prompt. CS's entity customer-ID information, the final UL_{POST}, the LI and any prompt(s) may be linked together in conjunction with entity databases. From step 330, the system may proceed to point B (circled), from which the system may proceed to process 200 illustrated in FIG. 2.

At step 369, CS may deem none of the service-executions listed in the complete UL_{A} as having not been executed completely and satisfactorily at step 367. In addition, CS may have no other service-executions to be listed in a UL_{POST}. If those conditions are met, the system may proceed from step 369 to step 370. At step 370, the system may cancel the UL (with concomitant reduction of the value of the number “x” of ULs linked with CS's customer-ID) and may proceed to step 398; at step 398, the system may end CS's Smart Queuing session.

As will be appreciated by one of skill in the art, the invention described in the aforementioned steps of processes 200 and 300; in other steps of processes 200 and 300 of FIGS. 2 and 3, respectively; in the apparatus illustratively shown in FIG. 1 presented herein; and in the specifications thereof presented herein, may be embodied in whole or in part as a method, a data processing system, or a computer program product. Accordingly, the invention may take the form of an entirely hardware embodiment, an entirely software embodiment or an embodiment combining software, hardware and any other suitable approach or apparatus. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Thus, methods and apparatus for Smart Queuing according to the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. A method for expediting execution of a financial service offered by a financial entity, the service selected by a customer of the entity, the method comprising:
receiving a selection of the financial service;
receiving a customer-setting of at least one parameter of the service;
queuing the selection and the at least one customer-set parameter into a listing, the listing comprising one or more financial service-selections;
associating a unique identifier with the listing;
transmitting the unique identifier to the customer; and
upon secure receipt of the unique identifier by the entity, executing the service according to:
a ranking of the service in the listing; and
the at least one customer-set parameter.

2. The method of claim 1, wherein the selection of the financial service comprises a financial transactional service, the financial transactional service selected from a menu of services offered through a customer-entity interface.

3. The method of claim 2, wherein the at least one parameter comprises an amount associated with the financial transactional service.

4. The method of claim 1 further comprising, prior to the queuing, setting a plurality of customer-settable parameters of the service.

5. The method of claim 1, wherein transmitting the identifier comprises issuing a physical article.

6. The method of claim 1, wherein the service is executed proximal to the customer.

7. The method of claim 1, wherein the secure receipt comprises receipt of information identifying the customer, said information received at a site of customer-identification input.

8. The method of claim 7 further comprising:
upon receiving a value associated with proximity of the customer to the site prior to customer-identification input, prioritizing the listing;
wherein the prioritizing comprises alerting an entity associate to the listing and to the proximity of the customer.

9. The method of claim 8, wherein the proximity is physical proximity.

10. The method of claim 1, wherein:
the customer is a first customer;
the service is a first service;
the listing is a first listing; and
the executing is a first executing;
if a second customer awaits a second executing of a second service, said second service not queued into a second listing, the method further comprises executing the first service preferentially to the second service.

11. The method of claim 1, wherein:
the customer is a first customer;
the service is a first service;
the listing is a first listing;
the unique identifier is a first unique identifier;
the secure receipt is a first secure receipt; and
the method further comprises:
queuing a second service into a second listing; and
executing the first service preferentially to the second service;
wherein the first secure receipt of the first unique identifier is preferred to a second secure receipt of a second unique identifier.

12. The method of claim 11, wherein the first secure receipt being preferred to the second secure receipt comprises a precedence of temporal order of receipt.

13. The method of claim 1 further comprising the executing being implemented by the financial entity for the customer according to an entity-set consideration, the entity-set consideration comprising prevention of customer-account depletion.

14. An article of manufacture comprising:
a computer usable medium having computer readable program code embodied therein for providing expediting execution of a financial service offered by a financial entity, the computer readable program code in said article of manufacture comprising:
computer readable program code for causing the computer to receive:
a selected financial service; and
a customer-setting of at least one parameter of the service;
computer readable program code for causing the computer to queue the selection and the at least one customer-set parameter into a listing, the listing comprising at least one financial service-selection;
computer readable program code for causing the computer to associate an unique identifier with the listing;
computer readable program code for causing the computer to transmit the unique identifier to the customer; and
computer readable program code for causing the computer to, upon secure receipt of the unique identifier by the entity, execute the service according to:
a ranking of the service in the listing; and
the at least one customer-set parameter.

15. The article of manufacture of claim 14, wherein:
the customer is a first customer;
the service is a first service;
the listing is a first listing;
the unique identifier is a first unique identifier;
the computer readable program code in said article of manufacture further comprises:
computer readable program code for causing the computer to queue a second service into a second listing; and
computer readable program code for causing the computer to execute the second service preferentially to the first service based on comparing a first preference associated with the first unique identifier of the first service to a second preference associated with a second unique identifier of the second service.

16. The article of manufacture of claim 15, wherein the first service is selected by the first customer and the second service is selected by a second customer.

17. The article of manufacture of claim 15, wherein the first unique identifier is received by the financial entity prior to the second unique identifier.

18. An apparatus for expediting execution of a financial service offered by a financial entity, the apparatus comprising:
a receiver that receives:
a selection of the financial service;
a customer-setting of at least one parameter of the service;
a processor executing instructions that:
queue the selection and the at least one customer-set parameter into a listing, the listing comprising one or more financial service-selections;
associate an unique identifier with the listing;
a transmitter that transmits the unique identifier to the customer; and
the processor further executing instructions that upon secure receipt of the unique identifier by the entity provide the service according to:
a ranking of the service in the listing; and
the at least one customer-set parameter.

19. The apparatus of claim 18 wherein the transmitter is further configured to issue a physical article to the customer.

20. The apparatus of claim 18, wherein:
the receiver receives:
a first value associated with proximity of the customer to a site during customer-identification input; and
a second value associated with the proximity of the customer to the site prior to customer-identification input; and
the processor executes instructions that:
calculates a third value based on comparing the second value to the first value; and
prioritizes the listing based on the third value;
wherein the prioritizing comprises alerting an entity associate to the listing and to the proximity of the customer.
